(19) United States
(12) Patent Application Publication
(10) Pub. No.: US 2026/0070851 A1
(43) Pub. Date: Mar. 12, 2026

(54) DISPERSIBLE ACTIVATED BAUXITE GRANULES AND METHODS FOR FORMING DISPERSIBLE ACTIVATED BAUXITE GRANULES

(71) Applicant: PHOSPHOLUTIONS INC., State College, PA (US)

(72) Inventors: Kyle J. ISAACSON, Parrish, FL (US); Pauline WELIKHE, Bellefonte, PA (US); Taylor STREHL, Stillman Valley, IL (US); Aaron WALTZ, Rockford, IL (US); Carlos A. LEÓN Y LEÓN, Bellefonte, PA (US)

(21) Appl. No.: 19/104,581

(22) PCT Filed: Aug. 17, 2023
(86) PCT No.: PCT/US2023/030418

§ 371 Date: Feb. 18, 2025

Related U.S. Application Data
(60) Provisional application No. 63/399,384, filed on Aug. 19, 2022.

(51) Int. Cl. C05B 7/00; C05B 1/02; C05B 19/00; C05G 3/20; C05G 5/12; C05G 5/27

(52) U.S. Cl. CPC C05B 7/00; C05B 1/02; C05B 19/00; C05G 3/20; C05G 5/12; C05G 5/27

(57) ABSTRACT

Dispersible activated bauxite granules are disclosed and methods for forming dispersible activated bauxite granules are disclosed in which bauxite is activated by a granulation process.

### RELATED APPLICATIONS

This application claims the benefit of and priority to U.S. Provisional Patent Application No. 63/399,384, filed Aug. 19, 2022, entitled “Dispersible Activated Bauxite Granules and Methods for Forming Dispersible Activated Bauxite Granules,” which is hereby incorporated by reference in its entirety.

### FIELD OF THE INVENTION

This application is directed to dispersible activated bauxite granules and methods for forming dispersible activated bauxite granules. In particular, this application is directed to dispersible activated bauxite granules and methods for forming the dispersible activated bauxite granules in which bauxite is activated by a granulation process.

### BACKGROUND OF THE INVENTION

While aluminum oxide materials may be produced from a variety of raw materials, aluminum oxide materials are most commonly derived from bauxite ore for production at a commercial scale. The aluminum oxide materials produced from bauxite sources may be manufactured through a variety of methods, yet nearly all involve some form of calcination and/or chemical activation, especially at commercial scale. In the conventional process, bauxite ore is typically dried to a desired moisture content and crushed or milled to desired size. Then, the fine bauxite powder is modified by the Bayer Process, which involves pressure heating between 150-200° C. in caustic soda. Through filtering, bauxite residue (also referred to as red mud, red sludge, bauxite tailings, or alumina refinery residues) is removed and sodium aluminate remains. The sodium aluminate is then treated with aluminum hydroxide and water, which promotes the removal of sodium hydroxide, and the resulting product is aluminum trihydrate. For commercial production, the aluminum trihydrate is generally calcined at defined temperatures and durations to achieve proper surface area and porosity characteristics for the desired application. The calcination procedure promotes expulsion of crystalline water and leads to atomic rearrangement. The activated alumina with highest surface area is usually obtained with calcination temperatures between 250-550° C.

Besides traditional calcination procedures, some level of activation of alumina trihydrate may occur via acid treatment, including partial acid dissolution and subsequent precipitation, which leads to a high porosity pseudoboehmite structure. Though not often performed at commercial scale, acid treatments and calcination procedures may be performed simultaneously with often synergistic activation impacts (e.g., acid treatment lowers the necessary calcination temperature to achieve desired characteristics).

Bauxite, not yet converted to aluminum trihydrate, may also be activated via temperature and pH treatments without undergoing the purifying Bayer Process. However, such activated bauxites contain considerable amounts of many other components besides aluminum oxide/oxyhydroxide/hydrate materials. For this reason, most applications (e.g., catalysts and water treatments) opt for activated alumina materials over activated bauxites, despite properly activated bauxites being able to achieve similar surface area and porosity characteristics with less energy input and reduced environmental waste.

It has been well-established that alumina-based materials may beneficially promote sorption of orthophosphates in agricultural soils, alleviating nutrient runoff effects while still providing sufficient crop fertility. Additional benefits have been observed when the alumina-based materials are pre-treated with phosphoric acid. This treatment effectively leads to “loading” of the alumina surface with adsorbed orthophosphate, and the loaded material may serve as the sole source of added phosphate to soils. This treatment essentially eliminates the need for the alumina amendment to capture phosphates in the soil environment and may lead to greater buffering capacity in the soils.

In agricultural applications, soil amendments and fertilizers are often derived from various ores with high concentrations of desired mineral components. Since purification and filtration practices are not always performed to minimize production costs, agricultural standard practice already supports inclusion of undesired or inert ore components in plant fertility programs. Provided that the inactive filler materials do not contain high levels of certain heavy metals or radioactive materials, these inactive materials are well-tolerated by crop systems.

Many fertilizers are formulated into granules to improve the ability to spread the nutrients over large areas. Granulation processes typically rely on either agglomeration or accretion to achieve size growth. In large-scale granule production, drum granulators are most commonly used as they may be engineered to handle both binder-based agglomeration and chemical reaction-based accretion processes. Most often, excess moisture in the granules is removed via rotary dryer as part of the production process.

Globally, 90% of phosphoric acid produced is utilized in some capacity as a fertilizer (38% diammonium phosphate (“DAP”), 29% monoammonium phosphate (“MAP”), 8% triple superphosphate (“TSP”), 15% other fertilizers such as single superphosphate (“SSP”)). In the United States, MAP usage exceeds that of DAP, and its market share is expanding. Nearly all phosphoric acid for fertilizer applications is produced via a multi-step process that involves the mining of phosphate rock, beneficiation, and a concentrated sulfuric acid treatment. Following the production of phosphoric acid of suitable purity, the phosphoric acid may be subjected to a variety of other processing treatments to produce liquid fertilizers, solid fertilizers, animal feed products, and more.

While the production processes differ for each solid fertilizer type (e.g., MAP, DAP, granulated TSP, and granulated SSP), several process similarities exist as well. For example, with phosphate ammoniation-granulation plants (those that produce MAP and DAP), the only significant difference is the input ratio of ammonia to phosphoric acid. Otherwise, all equipment and instrumentation for MAP and DAP production may essentially remain the same in the two processes. While manufacturing processes may also differ between locales, the essential process is largely standardized across the industry. Indeed, a majority of all ammoniation-granulation plants in the U.S. use a specific type of rotary drum mixer that was developed and patented by the Tennessee Valley Authority (“TVA”), either including a pre-neutralization step or a pipe cross reactor. The basic rotary drum ammoniator-granulator is designed with an open-end rotary cylinder which houses the rolling bed of recycled solids.

In the TVA phosphoric acid ammoniation-granulation process, phosphoric acid is mixed with about 93 wt % sulfuric acid in an acid surge tank (see FIG. 1). The mixed acids are then fed into a brick-lined acid reactor, where they are partially neutralized with liquid or gaseous anhydrous ammonia. About 70 wt % of all ammonia is introduced into this reactor vessel, producing a slurry of ammonium phosphate and about 22 wt % water that is transported into the rotary drum ammoniator-granulator and distributed along the bed. The remaining about 30 wt % of ammonia is sparged from underneath the slurry. Agglomeration occurs in the rotating drum and is terminated in the dryer. The moist granules then pass through the rotary concurrent dryer before being brought to ambient temperatures in the cooler.

Ammoniation granulation may also be performed with additional acids besides phosphoric acid, including sulfuric acid and nitric acid, producing ammonium sulfate and ammonium nitrate, respectively.

In contrast, for granulated TSP, the majority is produced with the Dorr-Oliver granulation process (see FIG. 3), which involves acid-controlled phosphoric acid and ground phosphate rock being fed into a reactor, with the ground rock and phosphoric acid slurry being fed into a granulator and subsequently dried in a generally continuous fashion. Granulated SSP follows a similar process; however, the ground phosphate rock is reacted with sulfuric acid in lieu of phosphoric acid. Granulated nitrophosphate may follow a similar process; ground phosphate rock is reacted with nitric acid in lieu of phosphoric acid.

### BRIEF DESCRIPTION OF THE INVENTION

In one exemplary embodiment, dispersible activated bauxite granules include at least one activated bauxite domain and at least one supplemental domain selected from the group consisting of at least one nutrient domain, at least one pesticide domain, at least one biological additive domain, at least one sorbent domain, and combinations thereof. The at least one bauxite domain and the at least one supplemental domain are present in the dispersible activated bauxite granule as distinct domains clustered together.

In another exemplary embodiment, dispersible activated bauxite granules include activated bauxite particles and water-soluble binder agglomerating the plurality of activated bauxite particles into the dispersible activated bauxite granules. The activated bauxite particles are free of chemical modification with NaOH.

In another exemplary embodiment, a method for forming coherent dispersible activated bauxite granules includes disposing at least one acid in an acid surge tank 10, reacting the at least one acid with ammonia in a reactor vessel 20 to form at least one of ammonium salt, introducing bauxite particles into the presence of the at least one ammonium salt, co-agglomerating the at least one ammonium salt and the bauxite particles in a rotary drum ammoniator-granulator to form coherent dispersible granules, and drying the coherent dispersible granules. At least one of the introducing bauxite particles into the presence of the at least ammonium salt and the drying the coherent dispersible granules activates the bauxite particles so as to form the coherent dispersible activated bauxite granules having a coherent dispersible activated bauxite granule crush strength of at least 5 lbf.

In another exemplary embodiment, a method for forming coherent dispersible activated bauxite granules includes mixing ground alkaline rock and at least one of phosphoric acid, sulfuric acid, or nitric acid in a reactor, reacting the ground alkaline rock with the at least one of the phosphoric acid, the sulfuric acid, or the nitric acid in the reactor to form at least one of a superphosphate slurry or a nitrophosphate slurry, introducing bauxite particles into the presence of the at least one of the superphosphate slurry or the nitrophosphate slurry, co-agglomerating the at least one of the superphosphate slurry or the nitrophosphate slurry and the bauxite particles in a rotary drum granulator to form coherent dispersible granules, and drying the coherent dispersible granules. At least one of the introducing bauxite particles into the presence of the at least one of the superphosphate slurry or the nitrophosphate slurry or the drying the coherent dispersible granules activates the bauxite particles so as to form the coherent dispersible activated bauxite granules having a coherent dispersible activated bauxite granule crush strength of at least 5 lbf.

In another exemplary embodiment, a method for forming coherent dispersible activated bauxite granules includes disposing at least one acid in a reactor, introducing bauxite particles into the presence of the at least one acid, co-agglomerating the at least one acid and the bauxite particles in a rotary drum granulator to form coherent dispersible granules, and drying the coherent dispersible granules. At least one of the introducing bauxite particles into the presence of the at least one of the at least one acid or the drying the coherent dispersible granules activates the bauxite particles so as to form the coherent dispersible activated bauxite granules having a coherent dispersible activated bauxite granule crush strength of at least 5 lbf.

In another exemplary embodiment, a method for forming coherent dispersible activated bauxite granules includes melting at least one of an acidic borate, an acidic phosphate, an acidic sulfate, or an acidic nitrate from a solid form to a liquid form, introducing bauxite particles into the presence of the at least one of the acidic borate, the acidic phosphate, the acidic sulfate, or the acidic nitrate, co-agglomerating the at least one of the acidic borate, the acidic phosphate, the acidic sulfate, or the acidic nitrate and the bauxite particles in a rotary drum granulator to form coherent dispersible granules, and drying the coherent dispersible granules. At least one of the introducing bauxite particles into the presence of the at least one of the acidic borate, the acidic phosphate, the acidic sulfate, or the acidic nitrate and the drying the coherent dispersible granules activates the bauxite particles so as to form the coherent dispersible activated bauxite granules having a coherent dispersible activated bauxite granule crush strength of at least 5 lbf.

In another exemplary embodiment, a method for forming agglomerated dispersible activated bauxite granules includes physically blending bauxite particles with supplemental particles selected from the group consisting of nutrient particles, pesticide particles, biological particles, sorbent particles, and combinations thereof, agglomerating the bauxite particles with the supplemental particles and at least one water-soluble binder to form agglomerated dispersible granules, and drying the agglomerated dispersible granules at a temperature of at least 250° F. to form the agglomerated dispersible activated bauxite granules.

Further aspects of the subject matter of the present disclosure are provided by the following clauses:

Dispersible activated bauxite granules, comprising at least one activated bauxite domain and at least one supplemental domain selected from the group consisting of at least one nutrient domain, at least one pesticide domain, at least one biological additive domain, at least one sorbent domain, and combinations thereof, wherein the at least one bauxite domain and the at least one supplemental domain are present in the dispersible activated bauxite granule as distinct domains clustered together.

The dispersible activated bauxite granules of any preceding clause, wherein the dispersible activated bauxite granules are coherent dispersible activated bauxite granules and the at least one activated bauxite domain and the at least one supplemental domain are present in the coherent dispersible activated bauxite granules as distinct domains coherently agglomerated together such that the coherent dispersible activated bauxite granules have a coherent dispersible bauxite granule crush strength of at least 5 lbf.

The dispersible activated bauxite granules of any preceding clause, wherein the dispersible activated bauxite granules are agglomerated dispersible activated bauxite granules.

The dispersible bauxite granules of any preceding clause, wherein the at least one supplemental domain includes the at least one nutrient domain, and the at least one nutrient domain includes at least one additive selected from the group consisting of bioavailable species of phosphorus, molybdenum, selenium, zinc, copper, cobalt, iron, nickel, manganese, vanadium, calcium, potassium, sulfur, chlorine, silicon, magnesium, sodium, nitrogen, boron, and combinations thereof.

The dispersible activated bauxite granules of any preceding clause, wherein the at least one nutrient domain includes at least one phosphate domain as the bioavailable species of phosphorus.

The dispersible activated bauxite granules of any preceding clause, wherein the at least one phosphate domain is selected from the group consisting of diammonium phosphate, monoammonium phosphate, triple superphosphate, single superphosphate, nitrophosphate, and combinations thereof.

The dispersible activated bauxite granules of any preceding clause, wherein the at least one supplemental domain includes the at least one biological domain, and the at least one biological domain includes at least one additive selected from the group consisting of humics, fulvics, living microbes, microbial metabolites, plant extracts, exogenous plant hormones, and combinations thereof.

The dispersible activated bauxite granules of any preceding clause, wherein the at least one supplemental domain includes the at least one pesticide domain, and the at least one pesticide domain includes at least one additive selected from the group consisting of herbicides, insecticides, fungicides, nematicides, and combinations thereof.

The dispersible activated bauxite granules of any preceding clause, wherein the at least one supplemental domain includes the at least one sorbent domain, and the at least one sorbent domain includes at least one additive selected from the group consisting of zeolites, zeotypes, and combinations thereof.

The dispersible activated bauxite granules of any preceding clause, wherein the at least one supplemental domain includes at least one phosphate domain and at least one of an additional nutrient domain other than a phosphate, the at least one pesticide domain, the at least one biological additive domain, and combinations thereof.

The dispersible activated bauxite granules of any preceding clause, wherein the at least one activated bauxite domain and the at least one supplemental domain are intragranularly homogenously distributed in the dispersible activated bauxite granules.

The dispersible activated bauxite granules of any preceding clause, wherein the at least one activated bauxite domain and the at least one supplemental domain are intergranularly homogenously distributed in the dispersible activated bauxite granules.

The dispersible activated bauxite granules of any preceding clause, having an activated bauxite domain: supplemental domain weight ratio from 5:1 to 1:5.

The dispersible activated bauxite granules of any preceding clause, further including at least one of a water-soluble binder, a suspension agent, or an emulsifying agent.

The dispersible activated bauxite granules of any preceding clause, further including at least one additional domain present as a distinct domain, wherein the at least one additional domain is selected from the group consisting of the at least one nutrient domain, the at least one pesticide domain, the at least one biological additive domain, the at least one sorbent domain, and combinations thereof.

The dispersible activated bauxite granules of any preceding clause, wherein the at least one additional domain is coherently agglomerated with the at least one activated bauxite domain and the at least one supplemental domain in the dispersible activated bauxite granules.

The dispersible activated bauxite granules of any preceding clause, wherein the at least one additional domain is agglomerated with the at least one activated bauxite domain and at least one supplemental domain in the dispersible activated bauxite granules.

The dispersible activated bauxite granules of any preceding clause, wherein the at least one additional domain is coated onto the clustered together at least one bauxite domain and the at least one supplemental domain.

The dispersible activated bauxite granules of any preceding clause, wherein the at least one activated bauxite domain has an alumina content of at least 35 wt % based on the total weight of the at least one activated bauxite domain.

The dispersible activated bauxite granules of any preceding clause, wherein the at least one activated bauxite domain has a combined alumina and iron oxide content of at least 55 wt % based on the total weight of the at least one activated bauxite domain.

The dispersible activated bauxite granules of any preceding clause, wherein the at least one activated bauxite domain includes activated mineral bauxite free of chemical modification with NaOH.

The dispersible activated bauxite granules of any preceding clause, wherein the at least one activated bauxite domain includes at least one of activated lateritic bauxite or activated karst bauxite.

Dispersible activated bauxite granules comprising activated bauxite particles and water-soluble binder agglomerating the plurality of activated bauxite particles into the dispersible activated bauxite granules, wherein the activated bauxite particles are free of chemical modification with NaOH.

The dispersible activated bauxite granules of any preceding clause, wherein the dispersible activated bauxite granules are disposed as a coating layer on a seed.

The dispersible activated bauxite granules of any preceding clause, wherein the activated bauxite particles have an alumina content of at least 35 wt % based on the total weight of the activated bauxite particles.

The dispersible activated bauxite granules of any preceding clause, wherein the activated bauxite particles have a combined alumina and iron oxide content of at least 55 wt % based on the total weight of the activated bauxite particles.

The dispersible activated bauxite granules of any preceding clause, wherein the activated bauxite particles include at least one of activated lateritic bauxite or activated karst bauxite.

The dispersible activated bauxite granules of any preceding clause, further including at least one of a suspension agent or an emulsifying agent.

The dispersible activated bauxite granules of any preceding clause, wherein the dispersible activated bauxite granules have a moisture content, by weight, of less than 10%.

The dispersible activated bauxite granules of any preceding clause, wherein the dispersible activated bauxite granules have a size of less than 0.6 mm.

A method for forming coherent dispersible activated bauxite granules comprising disposing at least one acid in an acid surge tank, reacting the at least one acid with ammonia in a reactor vessel to form at least one ammonium salt, introducing bauxite particles into the presence of the at least one of the ammonium salt, co-agglomerating the at least one of the ammonium salt and the bauxite particles in a rotary drum ammoniator-granulator to form coherent dispersible granules, and drying the coherent dispersible granules, wherein at least one of the introducing bauxite particles into the presence of the at least one ammonium salt and the drying the coherent dispersible granules activates the bauxite particles so as to form the coherent dispersible activated bauxite granules having a coherent dispersible activated bauxite granule crush strength of at least 5 lbf.

The method of any preceding clause, wherein the at least one acid is selected from the group consisting of boric acid, phosphoric acid, sulfuric acid, nitric acid, and combinations thereof, and the at least one ammonium salt is selected from the groups consisting of ammonium pentaborate, ammonium phosphate, ammonium sulfate, ammonium nitrate, and combinations thereof.

The method of any preceding clause, wherein introducing the bauxite particles into the presence of the at least one of the ammonium salt includes premixing the bauxite particles with the at least one acid prior to reacting the at least one acid with the ammonia.

The method of any preceding clause, wherein introducing the bauxite particles into the presence of the at least ammonium salt includes adding the bauxite particles into at least one of the acid surge tank, the reactor vessel, or the rotary drum ammoniator-granulator.

The method of any preceding clause, wherein the reactor vessel is a pipe cross reactor.

The method of any preceding clause, wherein introducing the bauxite particles into the presence of the at least one ammonium salt includes feeding the bauxite particles through the pipe cross reactor.

The method of any preceding clause, wherein drying the coherent dispersible granules includes drying the coherent dispersible granules in a rotary dryer.

The method of any preceding clause, further including introducing the bauxite particles into the rotary dryer.

A method for forming coherent dispersible activated bauxite granules comprising mixing ground alkaline rock and at least one of phosphoric acid, sulfuric acid, or nitric acid in a reactor, reacting the ground alkaline rock with the at least one of the phosphoric acid, the sulfuric acid, or the nitric acid in the reactor to form at least one of a superphosphate slurry or a nitrophosphate slurry, introducing bauxite particles into the presence of the at least one of the superphosphate slurry or the nitrophosphate slurry, co-agglomerating the at least one of the superphosphate slurry or the nitrophosphate slurry and the bauxite particles in a rotary drum granulator to form coherent dispersible granules, and drying the coherent dispersible granules, wherein at least one of the introducing bauxite particles into the presence of the at least one of the superphosphate slurry or the nitrophosphate slurry or the drying the coherent dispersible granules activates the bauxite particles so as to form the coherent dispersible activated bauxite granules having a coherent dispersible activated bauxite granule crush strength of at least 5 lbf.

The method of any preceding clause, wherein the ground alkaline rock is ground phosphate rock.

The method of any preceding clause, wherein introducing the bauxite particles into the presence of the at least one of the superphosphate slurry or the nitrophosphate slurry includes premixing the bauxite particles with the at least one of the phosphoric acid, the sulfuring acid, or the nitric acid prior to mixing the at least one of the phosphoric acid, the sulfuric acid, or the nitric acid with the ground alkaline rock.

The method of any preceding clause, wherein introducing the bauxite particles into the presence of the at least one of the superphosphate slurry or the nitrophosphate slurry includes adding the bauxite particles into at least one of an acid control tank upstream of the reactor, an alkaline rock weigher feeder upstream of the reactor, the reactor, or the rotary drum granulator.

The method of any preceding clause, wherein drying the coherent dispersible granules includes drying the coherent dispersible granules in a rotary dryer.

The method of any preceding clause, further including introducing the bauxite particles into the rotary dryer.

A method for forming coherent dispersible activated bauxite granules comprising disposing at least one acid in a reactor, introducing bauxite particles into the presence of the at least one acid, co-agglomerating the at least one acid and the bauxite particles in a rotary drum granulator to form coherent dispersible granules, and drying the coherent dispersible granules, wherein at least one of the introducing bauxite particles into the presence of the at least one acid or the drying the coherent dispersible granules activates the bauxite particles so as to form the coherent dispersible activated bauxite granules having a coherent dispersible activated bauxite granule crush strength of at least 5 lbf.

The method of any preceding clause, wherein the at least one acid is selected from the group consisting of boric acid, phosphoric acid, sulfuric acid, nitric acid, and combinations thereof.

The method of any preceding clause, wherein drying the coherent dispersible granules includes drying the coherent dispersible granules in a rotary dryer.

The method of any preceding clause, further including introducing the bauxite particles into the rotary dryer.

A method for forming coherent dispersible activated bauxite granules comprising melting at least one of an acidic borate, an acidic phosphate, an acidic sulfate, or an acidic nitrate from a solid form to a liquid form, introducing bauxite particles into the presence of the at least one of the acidic borate, the acidic phosphate, the acidic sulfate, or the acidic nitrate, co-agglomerating the at least one of the acidic borate, the acidic phosphate, the acidic sulfate, or the acidic nitrate and the bauxite particles in a rotary drum granulator to form coherent dispersible granules, and drying the coherent dispersible granules, wherein at least one of the introducing bauxite particles into the presence of the at least one of the acidic borate, the acidic phosphate, the acidic sulfate, or the acidic nitrate and the drying of the coherent dispersible granules activates the bauxite particles so as to form the coherent dispersible activated bauxite granules having a coherent dispersible activated bauxite granule crush strength of at least 5 lbf.

The method of any preceding clause, wherein the acidic phosphate is selected from the group consisting of monoammonium phosphates, diammonium phosphates, and combinations thereof.

The method of any preceding clause, wherein melting the at least one of the acidic borate, the acidic phosphate, the acidic sulfate, or the acidic nitrate includes and co-agglomerating the at least one of the acidic borate, the acidic phosphate, the acidic sulfate, or the acidic nitrate and the bauxite particles includes a steam granulation process.

A method for forming agglomerated dispersible activated bauxite granules comprising physically blending bauxite particles with supplemental particles selected from the group consisting of nutrient particles, pesticide particles, biological particles, sorbent particles, and combinations thereof, agglomerating the bauxite particles with the supplemental particles and at least one water-soluble binder to form agglomerated dispersible granules, and drying the agglomerated dispersible granules at a temperature of at least 250° F. to form the agglomerated dispersible activated bauxite granules.

The method of any preceding clause, wherein the nutrient particles include constituents selected from the group consisting of bioavailable species of phosphorus, molybdenum, selenium, zinc, copper, cobalt, iron, nickel, manganese, vanadium, calcium, potassium, sulfur, chlorine, silicon, magnesium, sodium, nitrogen, boron, and combinations thereof.

The method of any preceding clause, wherein the nutrient particles include phosphate as the bioavailable species of phosphorus.

The method of any preceding clause, wherein the phosphate is selected from the group consisting of diammonium phosphate, monoammonium phosphate, triple superphosphate, single superphosphate, nitrophosphate, and combinations thereof.

The method of any preceding clause, wherein the biological particles include constituents selected from the group consisting of humics, fulvics, living microbes, microbial metabolites, plant extracts, exogenous plant hormones, and combinations thereof.

The method of any preceding clause, wherein the pesticide particles include constituents selected from the group consisting of herbicides, insecticides, fungicides, nematicides, and combinations thereof.

The method of any preceding clause, wherein the sorbent particles include constituents selected from the group consisting of zeolites, zeotypes, and combinations thereof.

### BRIEF DESCRIPTION OF THE DRAWINGS

These and other features, aspects, and advantages of the present subject matter will become better understood when the following detailed description is read with reference to the accompanying drawings in which:

FIG. 1 is a production schematic for MAP and DAP from phosphoric acid when using a pre-neutralization step, as known and presently used.

FIG. 2 is a production schematic for coherent dispersible activated bauxite granules, according to an embodiment of the present disclosure.

FIG. 3 is a production schematic for granulated TSP and granulated SSP from at least one of phosphoric acid or sulfuric acid and phosphate rock, as known and presently used. A production schematic for nitrophosphate would be identical other than replacing sulfuric acid or phosphoric acid with nitric acid. A production schematic for ammonium pentaborate would be identical other than replacing sulfuric acid or phosphoric acid with boric acid.

FIG. 4 is a production schematic for coherent dispersible activated bauxite granules, according to an embodiment of the present disclosure.

FIG. 5 is a cross-sectional schematic view of a dispersible activated bauxite granule, according to an embodiment of the present disclosure.

FIG. 6 is a graph comparing predicted available P₂O₅ versus experimentally determined P₂O₅ in granules, according to an embodiment of the present disclosure.

FIG. 7 is a thermogravimetric analysis of bauxite, bauxite-embedded ammonium phosphate granules, and produced monoammonium phosphate, according to an embodiment of the present disclosure.

FIG. 8 is a plot comparing measured total nitrogen content of granules versus P₂O₅ content, according to an embodiment of the present disclosure.

FIG. 9 is a graph comparing ammonia input reduction versus activated bauxite content in granules, according to an embodiment of the present disclosure.

FIG. 10 is a graph comparing reduction in granular nitrogen content with activated bauxite content in granules, according to an embodiment of the present disclosure.

FIG. 11 is a graph comparing reduction in nitrogen content from projected nitrogen content with activated bauxite content in granules, according to an embodiment of the present disclosure.

FIG. 12 is a graph showing the effect of calcination-based methods on P₂O₅ adsorption of bauxite (Bauxite #1), according to an embodiment of the present disclosure.

FIG. 13 is a graph comparing P₂O₅ availability with activated bauxite content in granules, according to an embodiment of the present disclosure.

FIG. 14 is a graph comparing P₂O₅ availability with activated bauxite content in granules, according to an embodiment of the present disclosure.

FIG. 15 is a plot of phosphate release from various granules over time, according to an embodiment of the present disclosure.

FIG. 16 is a graph showing calculated crystalline water loss during granulation, according to an embodiment of the present disclosure.

FIG. 17 is a graph showing calculated loss-on-ignition of bauxites during granulation, according to an embodiment of the present disclosure.

FIG. 18 is a graph comparing propensity to volatilize crystalline water from lattices for different bauxites, according to an embodiment of the present disclosure.

FIG. 19 is a plot correlating activated bauxite content and reduction in ammonia input during granulation, according to an embodiment of the present disclosure.

FIG. 20 is a graph comparing calculated ammonia reduction based on ammonia-phosphoric acid imbalance as determined via titration of granules exiting a granulator with activated bauxite content of the granules, according to an embodiment of the present disclosure.

FIG. 21 is a graph comparing ammonia reduction versus activated bauxite content for different bauxites, according to an embodiment of the present disclosure.

FIG. 22 is a graph comparing water-soluble, citrate-soluble, and citrate-insoluble P₂O₅ with activated bauxite content for a first bauxite, according to an embodiment of the present disclosure.

FIG. 23 is a graph comparing water-soluble, citrate-soluble, and citrate-insoluble P₂O₅ with activated bauxite content for a second bauxite, according to an embodiment of the present disclosure.

FIG. 24 is a graph comparing water-soluble, citrate-soluble, and citrate-insoluble P₂O₅ with activated bauxite content for a third bauxite, according to an embodiment of the present disclosure.

FIG. 25 is a graph comparing granules produced by size versus raw bauxite inclusion rate, according to an embodiment of the present disclosure.

Wherever possible, the same reference numbers will be used throughout the drawings to represent the same features.

### DETAILED DESCRIPTION OF THE INVENTION

Disclosed herein are dispersible activated bauxite granules and methods for forming the dispersible activated bauxite granules in which bauxite is activated by a granulation process. Although raw bauxites may be able to buffer phosphorus in soil systems in a similar manner as activated alumina, the orthophosphate “pre-loading” capacity of raw bauxites is substantially less than activated alumina. Therefore, activated alumina outperforms known bauxite amendments in orthophosphate pre-loaded systems. However, properly activated bauxites perform more similarly to activated alumina in phosphate-loading scenarios. Embodiments of the present disclosure, in contrast to granules and methods lacking one or more of the features disclosed herein, have greater production efficiency, decreased costs, decreased granule-to-granule variability, increased phosphate absorption, lesser environmental impact, or combinations thereof.

As used herein, “about” indicates a variance of up to 10% from the value being so modified. All values modified with “about” are also intended to convey the unmodified value as an alternative, so that “about 10 μm,” by way of examples, discloses both a range of 9-11 μm as well as specifically 10 μm.

As used herein, “coherent” dispersible granules are differentiated from “agglomerated” dispersible granules in that “agglomerated” refers to granules formed by mechanically agglomerating at least two types of preformed particles together, whereas “coherent” refers to granules formed by agglomerating one type of preformed particle with a second domain of material which is being simultaneously formed. Structural distinctions between coherent dispersible granules and agglomerated dispersible granules include, but are not limited to, greater granule crush strength, improved resistance to attrition, reduced moisture content, greater hygroscopic stability, less intergranular variability in bauxite: supplemental weight ratio, greater contact surface area between bauxite domains 2 and phosphate domains 3 resulting in tighter adhesion, increased bauxite surface area, reduced binder incorporation, a greater degree of intermixed domains, or combinations thereof.

As used herein “activated” indicates a material which has reduced crystalline water, increased surface area, and crystalline phases with greater stability than the same material in un-activated form.

In one embodiment, methods for forming coherent dispersible activated bauxite granules 1 include ammoniation-granulation processes with any suitable acid, including, but not limited to, boric acid, phosphoric acid, sulfuric acid, nitric acid, or combinations thereof, granulation processes with any suitable acid, including, but not limited to, boric acid, phosphoric acid, sulfuric acid, nitric acid, or combinations thereof, granulation processes with phosphoric acid, sulfuric acid, nitric acid, or combinations thereof and ground alkaline rock, or granulation processes with liquid acidic borate, liquid acidic phosphate, liquid acidic sulfate, liquid acidic nitrate, or combinations thereof melted from a solid state. In another embodiment, methods for forming agglomerated dispersible activated bauxite granules include physically blending bauxite particles with supplemental particles and at least one water-soluble binder and then drying at a temperature of at least 250° F.

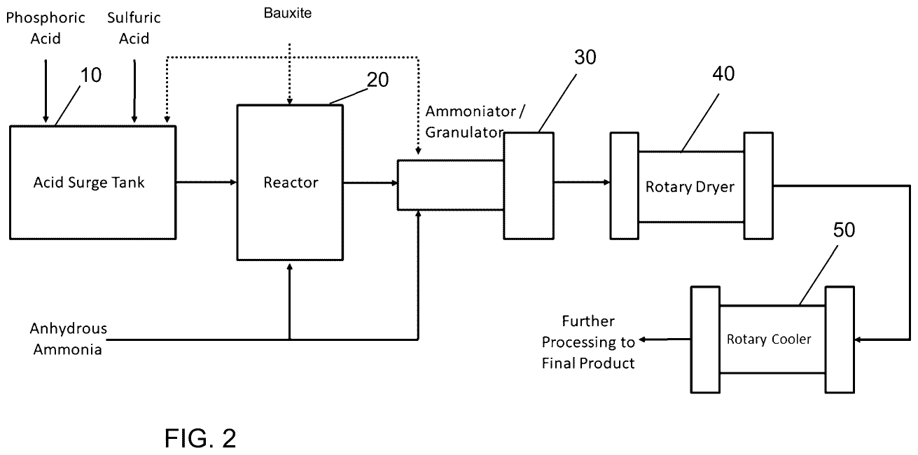

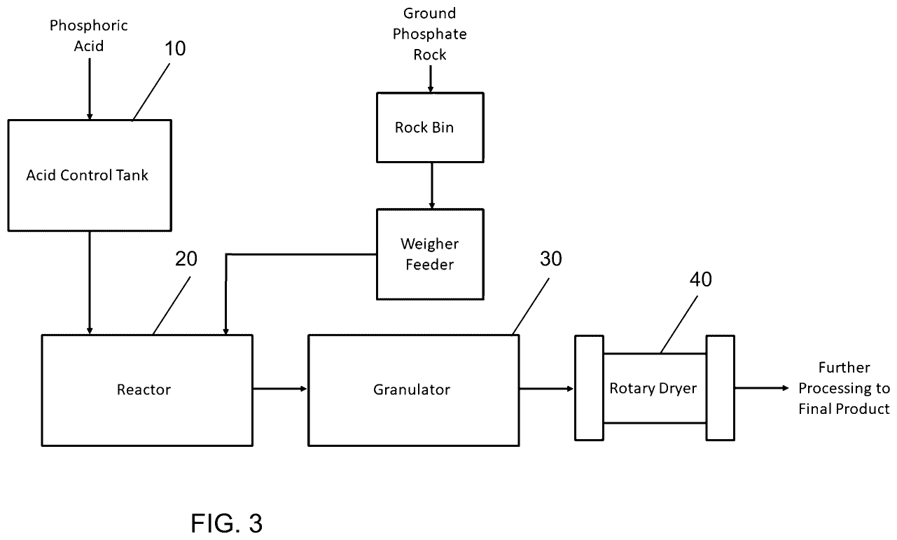

Referring to FIG. 2, in one embodiment, a method for forming coherent dispersible activated bauxite granules 1 includes disposing at least one acid, such as, but not limited to, boric acid, phosphoric acid, sulfuric acid, nitric acid, or combinations thereof in an acid surge tank 10, reacting the at least one acid with ammonia in a reactor vessel 20 to form at least one ammonium salt, including, but not limited to, ammonium pentaborate, ammonium phosphate, ammonium sulfate, ammonium nitrate, or combinations thereof, introducing bauxite particles into the presence of the at least one ammonium salt, co-agglomerating the at least one ammonium salt and the bauxite particles in a rotary drum ammoniator-granulator 30 to form coherent dispersible granules, and drying the coherent dispersible granules. At least one of the introducing bauxite particles into the presence of the at least one ammonium salt and the drying the coherent dispersible granules activates the bauxite particles so as to form the coherent dispersible activated bauxite granules 1 having a coherent dispersible activated bauxite granule crush strength of at least 5 lbf. The at least one activated bauxite domain 2 and the at least one phosphate, sulfate, or nitrate domain 3 are present in the coherent dispersible activated bauxite granules 1 as distinct domains coherently agglomerated together.

Introducing the bauxite particles into the presence of the at least one ammonium salt may include premixing the bauxite particles with the at least one acid prior to reacting the at least one acid with the ammonia. Introducing the bauxite particles into the presence of the at least one ammonium salt may include adding the bauxite particles into at least one of the acid surge tank 10, the reactor vessel 20, or the rotary drum ammoniator-granulator 30.

The reactor vessel 20 may be a pipe cross reactor. In one embodiment, introducing the bauxite particles into the presence of the at least one of the ammonium salt includes feeding the bauxite particles through the pipe cross reactor.

Drying the coherent dispersible granules 1 may include drying the coherent dispersible granules 10 in a rotary dryer 40. In one embodiment, the bauxite particles may be introduced into the rotary dryer 40. Optionally, the coherent dispersible granules 1 may be introduced into a rotary cooler 50 following the rotary dryer 40.

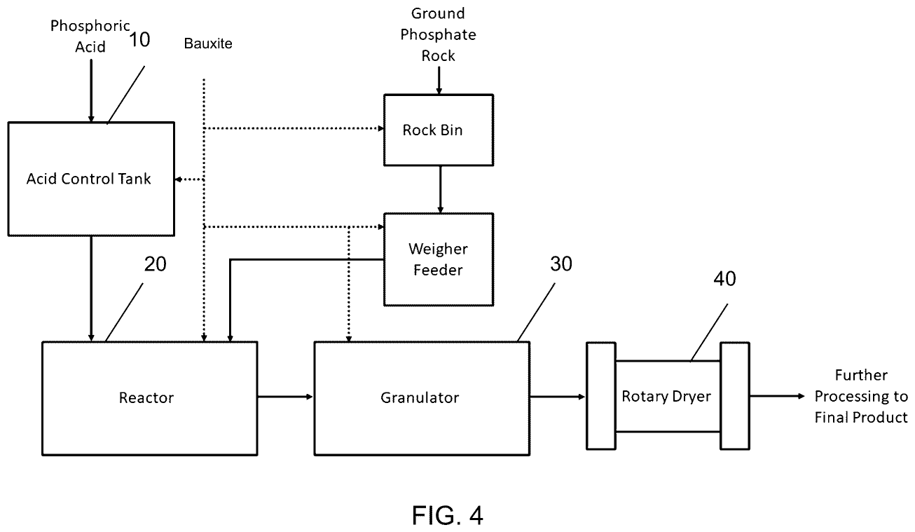

Referring to FIG. 4, in one embodiment, a method for forming coherent dispersible activated bauxite granules 1 includes mixing at least one of phosphoric acid, sulfuric acid, or nitric acid and ground alkaline rock in a reactor 20, feeding the slurry into a granulator 30, introducing bauxite particles into the presence of the agglomerating superphosphate or nitrophosphate, co-agglomerating the superphosphate or nitrophosphate and the bauxite particles in the granulator 30 to form the coherent dispersible granules 1, and drying the coherent dispersible granules 1, wherein at least one of the introducing bauxite particles into the presence of the at least one of the superphosphate slurry or the nitrophosphate slurry and the drying the coherent dispersible granules 1 activates the bauxite particles so as to form the coherent dispersible activated bauxite granules 1 having a coherent dispersible activated bauxite granule crush strength of at least 5 lbf. The at least one bauxite domain 2 and the at least one phosphate, sulfate, or nitrate domain 3 are present in the coherent dispersible activated bauxite granules 1 as distinct domains coherently agglomerated together. The ground alkaline rock may be ground phosphate rock.

Introducing the bauxite particles into the presence of the at least one of the superphosphate slurry or the nitrophosphate slurry may include premixing the bauxite particles with the at least one of the phosphoric acid, the sulfuric acid, or the nitric acid prior to mixing the at least one of the phosphoric acid, the sulfuric acid, or the nitric acid with the ground alkaline rock. Introducing the bauxite particles into the presence of the at least one of the superphosphate slurry or the nitrophosphate slurry may include adding the bauxite particles into at least one of an acid control tank upstream of the reactor, an alkaline rock weigher feeder upstream of the reactor, the reactor, or the rotary drum granulator 30.

Drying the coherent dispersible granules 1 may include drying the coherent dispersible granules 10 in a rotary dryer 40. In one embodiment, the bauxite particles may be introduced into the rotary dryer 40.

In another embodiment, a method for forming coherent dispersible activated bauxite granules 1 includes disposing at least one acid, such as, but not limited to, boric acid, phosphoric acid, sulfuric acid, nitric acid, or combinations thereof, in a reactor, introducing bauxite particles into the presence of the at least one acid, co-agglomerating the at least one of the at least one acid and the bauxite particles in a rotary drum granulator 30 to form coherent dispersible granules, and drying the coherent dispersible granules. At least one of the introducing bauxite particles into the presence of the at least one of the at least one acid or the drying the coherent dispersible granules 1 activates the bauxite particles so as to form the coherent dispersible activated bauxite granules 1 having a coherent dispersible activated bauxite granule crush strength of at least 5 lbf. The at least one bauxite domain 2 and the at least one phosphate domain 3 are present in the coherent dispersible activated bauxite granules 1 as distinct domains coherently agglomerated together.

Drying the coherent dispersible granules 1 may include drying the coherent dispersible granules 10 in a rotary dryer 40. In one embodiment, the bauxite particles may be introduced into the rotary dryer 40.

In another embodiment, a method for forming coherent dispersible activated bauxite granules 1 includes melting at least one of an acidic phosphate, an acidic sulfate, or an acidic nitrate from a solid form to a liquid form, introducing bauxite particles into the presence of the at least one of the acidic phosphate, the acidic sulfate, or the acidic nitrate, co-agglomerating the at least one of the acidic phosphate, the acidic sulfate, or the acidic nitrate and the bauxite particles in a rotary drum granulator 30 to form coherent dispersible granules, and drying the coherent dispersible granules. At least one of the introducing bauxite particles into the presence of the at least one of the acidic phosphate, the acidic sulfate, or the acidic nitrate and the drying the coherent dispersible granules 1 activates the bauxite particles so as to form the coherent dispersible activated bauxite granules 1 having a coherent dispersible activated bauxite granule crush strength of at least 5 lbf. The at least one bauxite domain 2 and the at least one phosphate, sulfate, or nitrate domain 3 are present in the coherent dispersible activated bauxite granules 1 as distinct domains coherently agglomerated together. The at least one acidic phosphate, an acidic sulfate, or an acidic nitrate may be, but is not limited to, a monoammonium phosphate, a diammonium phosphate, or combinations thereof. Melting the at least one acidic phosphate, an acidic sulfate, or an acidic nitrate and co-agglomerating the at least one acidic phosphate, an acidic sulfate, or an acidic nitrate and the bauxite particles may include any suitable process, including, but not limited to, a steam granulation process.

The acidic phosphate, acidic sulfate, or acidic nitrate may be any suitable materials, including, but not limited to, monoammonium phosphates, diammonium phosphates, or combinations thereof.

Melting the at least one of the acidic phosphate, the acidic sulfate, or the acidic nitrate and co-agglomerating the at least one of the acidic phosphate, the acidic sulfate, or the acidic nitrate and the bauxite particles may include a steam granulation process.

In another exemplary embodiment, a method for forming agglomerated dispersible activated bauxite granules 1 includes physically blending bauxite particles with supplemental particles selected from the group consisting of nutrient particles, pesticide particles, biological particles, sorbent particles, or combinations thereof, agglomerating the bauxite particles with the supplemental particles and at least one water-soluble binder to form agglomerated dispersible granules 1, and drying the agglomerated dispersible granules 1 at a temperature of at least 250° F. to form the agglomerated dispersible activated bauxite granules, alternatively at least 275° F., alternatively at least 300° F., alternatively at least 325° F., alternatively at least 350° F., alternatively at least 375° F., alternatively at least 400° F., alternatively at least 425° F., alternatively at least 450° F., alternatively at least 475° F., alternatively at least 500° F., alternatively at least 525° F., alternatively at least 550° F., alternatively at least 575° F., alternatively at least 600° F., alternatively at least 625° F., alternatively at least 660° F., alternatively at least 675° F., alternatively at least 700 OF, alternatively at least 725° F., alternatively at least 750° F., alternatively at least 775° F., alternatively at least 800° F., alternatively at least 825° F., alternatively at least 850° F., alternatively at least 875° F., alternatively at least 900° F.

The nutrient particles may include bioavailable species of phosphorus, molybdenum, selenium, zinc, copper, cobalt, iron, nickel, manganese, vanadium, calcium, potassium, sulfur, chlorine, silicon, magnesium, sodium, nitrogen, boron, or combinations thereof. The nutrient particles may include phosphate as the bioavailable species of phosphorus. The phosphate may be any suitable phosphate, including, but not limited to, diammonium phosphate, monoammonium phosphate, triple superphosphate, single superphosphate, nitrophosphate, or combinations thereof.

The biological particles may include humics, fulvics, living microbes, microbial metabolites, plant extracts, exogenous plant hormones, or combinations thereof.

The pesticide particles may include herbicides, insecticides, fungicides, nematicides, or combinations thereof.

The sorbent particles may include zeolites, zeotypes, or combinations thereof.

Referring to the foregoing methods, introducing the bauxite particles may include premixing the bauxite particles with the boric acid, the phosphoric acid, sulfuric acid, or nitric acid prior to introduction, adding the bauxite particles into an acid surge tank 10, adding the bauxite particles into a reactor vessel 20, adding the bauxite particles into a rotary drum ammoniator-granulator 30, or any combination thereof. In one embodiment, the bauxite particles are maintained within a pH range of about 1.5 to about 7.5 from introduction through coherent agglomeration or agglomeration, alternatively about 1.5 to 2.5, alternatively about 2 to 3, alternatively about 2.5 to 3.5, alternatively about 3 to 4, alternatively about 3.5 to 4.5, alternatively about 4 to 5, alternatively about 4.5 to 5.5, alternatively about 5 to 6, alternatively about 5.5 to 6.5, alternatively about 6 to 7, alternatively about 6.5 to 7.5, or any sub-range or combination thereof. Drying the dispersible bauxite granules 1 may include drying the dispersible bauxite granules 1 in a rotary dryer 40. Further bauxite particles may be introduced into the rotary dryer 40 to be dried and further agglomerated with the dispersible bauxite granules 1.

The coherent dispersible activated bauxite granules 1 may have a greater coherent dispersible activated bauxite granule crush strength than the agglomerated dispersible activated bauxite granules 1 formed by agglomerating the bauxite particles. In one embodiment, the coherent dispersible activated bauxite granules 1 have a coherent dispersible granule crush strength of at least 5 lbf, alternatively at least 5.5 lbf, alternatively at least 6 lbf, alternatively at least 6.5 lbf, alternatively at least 7 lbf, alternatively at least 7.5 lbf, alternatively at least 8 lbf, alternatively at least 8.5 lbf, alternatively at least 9 lbf, alternatively at least 9.5 lbf, alternatively at least 10 lbf.

The coherent dispersible activated bauxite granules 1 may have reduced intergranular bauxite: supplemental weight ratio variability than the agglomerated dispersible activated bauxite granules formed by agglomerating the bauxite particles with preformed supplemental particles, alternatively 5% less intergranular bauxite: supplemental weight ratio variability, alternatively 10% less, alternatively 15% less, alternatively 20% less, alternatively 25% less. In one embodiment, the coherent dispersible activated bauxite granules 1 have an intergranular variability in bauxite: supplemental weight ratio of +40%, alternatively ±35%, alternatively ±30%, alternatively ±25%, alternatively ±20%, alternatively ±15%. As used herein, intergranular variability is measured relative to the lesser component of bauxite and supplemental as measured by the average across the coherent dispersible activated bauxite granules 1 such that if the average bauxite: supplemental weight ratio is 50:50 with an intergranularity of ±40%, the bauxite: phosphate weight ratio may range from 30:70 to 70:30. By way of further explanation, if the average bauxite: supplemental weight ratio is 25:75 with an intergranularity of ±40%, the bauxite: supplemental weight ratio may range from 15:85 to 35:65.

Structural distinctions between “coherent dispersible granules” and “agglomerated dispersible granules” include, but are not limited to, greater granule crush strength, improved resistance to attrition, reduced moisture content, greater hygroscopic stability, less intergranular variability in bauxite: supplemental weight ratio, greater contact surface area between bauxite and supplemental domains 3, tighter adhesion between bauxite domains 2 and supplemental domains 3, increased bauxite surface area, reduced binder incorporation, a greater degree of intermixed domains, or combinations thereof.

In one embodiment, dispersible activated bauxite granules 1 include at least one activated bauxite domain 2 and at least one supplemental domain 3, wherein the at least one activated bauxite domain 2 and the at least one supplemental domain 3 are present in the dispersible activated bauxite granule 1 as distinct domains clustered together. The dispersible activated bauxite granules 1 may be coherent dispersible activated bauxite granules 1 or agglomerated dispersible activated bauxite granules 1.

The at least one supplemental domain 3 may include at least one nutrient domain, at least one pesticide domain, at least one biological additive domain, at least one sorbent domain, or combinations thereof.

Suitable at least one nutrient domains include, but are not limited to, bioavailable species of phosphorus, molybdenum, selenium, zinc, copper, cobalt, iron, nickel, manganese, vanadium, calcium, potassium, sulfur, chlorine, silicon, magnesium, sodium, nitrogen, boron, or combinations thereof. Bioavailable species of the foregoing nutrients include, but are not limited to, MoO₂⁻, ScO₂⁻, Zn²⁺, ZnCl⁻, CuCO₃, Co²⁺, Fe²⁺, Fe³⁺, Ni²⁺, NiCl⁺, Mn²⁺, MnCl⁺, HVO₄²⁻, Ca²⁺, K+, SO₄²⁻, Cl⁻, SiOH₄, Mg²⁺, Na⁺, NH⁴⁺, NO₃⁻, H₃BO₃, and B₄O₇²⁻. In one embodiment, the at least one nutrient domain includes at least one phosphate domain as the bioavailable species of phosphorus. Suitable phosphates for the bioavailable species include, but are not limited to, DAP, MAP, granulated TSP, granulated SSP, or combinations thereof.

Suitable at least one biological additive domains include, but are not limited to, humics, fulvics, living microbes, microbial metabolites, plant extracts, exogenous plant hormones, or combinations thereof. Any suitable variations of humic or fulvic acid-containing formulations or any materials of which are organic matter derived and contain numerous humic and/or fulvic acid species may be employed. Microbes may include, but are not limited to, Rhodopseudomonas spp., Bacillus spp., Pseudomonas spp., Saccharomyces spp., Aspergillus spp., Candida spp., Streptococcus spp., Lactobacillus spp., or combinations thereof. Plant extracts may include, but are not limited to, phytohormones, quinols, plastoquinones, flavonoids, plant-growth-promoting metabolites, or combinations thereof. Exogenous plant hormones may include, but are not limited to, IDAA, gibberellin, abscisic acid, auxins, jasmonates, brassinosteroids, cytokinins, salicylic acid, or combinations thereof.

Suitable at least one pesticide domains include, but are not limited to, herbicides, insecticides, fungicides, nematicides, or combinations thereof. Suitable herbicides include, but are not limited to, sulfonylureas, HPPD-inhibitors, chloroacetamides, PPO-inhibitors, phenylurea, triazines, or combinations thereof. Suitable insecticides include, but are not limited to, organophosphates, carbamides, pyrethrins, neonicotinoids, spinosins, indoxacarb, diamides, or combinations thereof. Suitable fungicides include, but are not limited to, strobilurines, pyrimidines, triazoles, dicarboximides, or combinations thereof. Suitable nematicides include, but are not limited to, avermectin, carbamates, organophosphates, or combinations thereof.

The at least one sorbent domain may include, but is not limited to, zeolites, zeotypes, or combinations thereof.

In one embodiment, the at least one supplemental domain 3 includes at least one phosphate domain and at least one of, at least two of, or each of, an additional nutrient domain other than a phosphate, the at least one pesticide domain, the at least one biological additive domain, or combinations thereof.

The dispersible activated bauxite granules 1 may include at least one layer disposed on the dispersible activated bauxite granules 1, wherein the at least one layer is at least one nutrient layer, at least one pesticide layer, at least one biological additive layer, at least one sorbent layer, or combinations thereof.

The at least one activated bauxite domain 2 and the at least one supplemental domain may be intragranularly homogenously or heterogeneously distributed in the dispersible activate bauxite granules 1. The at least one activated bauxite domain 2 and the at least one supplemental domain 3 may be intergranularly homogenously or heterogeneously distributed in the dispersible activated bauxite granules 1.

The dispersible activated bauxite granules 1 may be disposed on a seed as a coating layer.

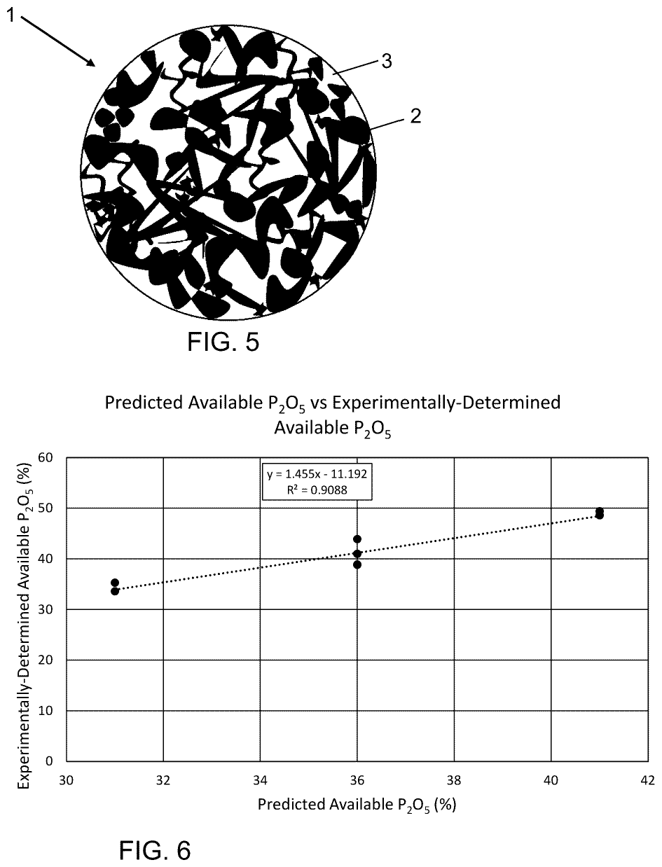

Referring to FIG. 5, in one embodiment, the coherent dispersible activated bauxite granules 1 include at least one activated bauxite domain 2, and at least one supplemental domain 3, wherein the at least one activated bauxite domain 2 and the at least one supplemental domain 3 are present in the coherent dispersible activated bauxite granules 1 as distinct domains coherently agglomerated together. The at least one supplemental domain 3 may be a phosphate domain 3 as the at least one nutrient domain 3. The at least one phosphate domain 3 may include, but is not limited to, MAP, DAP, granulated TSP, granulated SSP, or combinations thereof.

The at least one activated bauxite domain 2 and the at least one phosphate domain 3 may be intragranularly homogenously or heterogeneously distributed in the coherent dispersible activated bauxite granules 1. The at least one activated bauxite domain 2 and the at least one phosphate domain 3 may be intergranularly homogenously or heterogeneously distributed in the coherent dispersible activated bauxite granules 1.

In one embodiment, each of the at least one activated bauxite domain 2 is at least 50% surrounded by the at least one supplemental domain 3, alternatively at least 60% surrounded, alternatively at least 70% surrounded, alternatively at least 80% surrounded, alternatively at least 90% surrounded, alternatively at least 95% surrounded, alternatively at least 99% surrounded, alternatively entirely surrounded.

The dispersible activated bauxite granules 1 may have any suitable weight ratio of bauxite to phosphate, including, but not limited to, a weight ratio of 10:1 to 1:10, alternatively 8:1 to 1:8, alternatively 7:1 to 1:7, alternatively 6:1 to 1:6, alternatively 5:1 to 1:5, alternatively 4:1 to 1:4, alternatively 3:1 to 1:3, alternatively 2:1 to 1:2, alternatively 3:1 to 1:1, alternatively 1:1 to 1:3, alternative about 2:1, alternatively about 1:1, alternatively about 1:2, or any sub-range or combination of ranges thereof.

The dispersible activated bauxite granules 1 may further include at least one of a water-soluble binder, a suspension agent, or an emulsifying agent. In one embodiment, the dispersible activated bauxite granules 1 include, by weight, 1-40% water-soluble binder, alternatively 5-35%, alternatively 5-15%, alternatively 10-20%, alternatively 15-25%, alternatively 20-30%, alternatively 25-35%, or any sub-range or combination thereof. Suitable water-soluble binders include, but are not limited to, calcium lignosulfonate, ammonium lignosulfonate, or combinations thereof. Suitable suspension agents include, but are not limited to, polysaccharides, inorganic salts, carbomers, or combinations thereof. Suitable emulsifying agents include, but are not limited to, vegetable derivatives such as acacia, tragacanth, agar, pectin, carrageenan, or lecithin, animal derivatives such as gelatin, lanolin, or cholesterol, semi-synthetic agents such as methylcellulose, or carboxymethylcellulose, synthetics such as benzalkonium chloride, benzethonium chloride, alkali soaps (including sodium or potassium oleate), amine soaps (including triethanolamine stearate), detergents (including sodium lauryl sulfate, sodium dioctyl sulfosuccinate, or sodium docusate), sorbitan esters, polyoxyethylene derivatives of sorbitan esters, glyceryl esters, or combinations thereof. In another embodiment, the dispersible activated bauxite granules 1 are free of water-soluble binders, suspension agents, emulsifying agents, any two of the foregoing, or all of the foregoing.

The dispersible activated bauxite granules 1 may further include at least one additional domain present as a distinct domain. Suitable additional domains include, but are not limited to, at least one nutrient domain, at least one pesticide domain, at least one biological additive domain, at least one sorbent domain, or combinations thereof. The at least one additional domain may be coherently agglomerated with the at least one activated bauxite domain 2 and the at least one supplemental domain 3 in the dispersible activated bauxite granules 1, the at least one additional domain may be agglomerated with the agglomerated at least one activated bauxite domain 2 and at least one supplemental domain 3, the at least one additional domain may be coated onto the at least one activated bauxite domain 2 and at least one supplemental domain 3, individually or as clustered together in a dispersible activated bauxite granule 1, the at least one additional domain may be intermixed with the dispersible activated bauxite granules 1, or combinations thereof. By way of non-limiting example, in one embodiment, a coherent dispersible activated bauxite granule 1 could include at least one nutrient domain coherently agglomerated with the at least one bauxite domain 2 and the at least one phosphate domain 3, at least one pesticide domain agglomerated with the coherently agglomerated at least one nutrient domain, at least one activated bauxite domain 2, and at least one phosphate domain 3, and at least biological additive domain coated onto the at least one pesticide domain agglomerated with the coherently agglomerated at least one nutrient domain, at least one activated bauxite domain 2, and at least one supplemental domain 3.

The bauxite particles constituting the activated bauxite domain 2 may have any suitable size. In one embodiment, to maintain adsorptive capacity for phosphate and optimizing the bauxite particle size for penetrating the soil profile through a surface application, a preferred particle size for activated bauxite particles is smaller than about 300 μm, alternatively smaller than about 150 μm, alternatively smaller than about 100 μm, alternatively smaller than about 75 μm, alternatively smaller than about 50 μm, alternatively smaller than about 25 μm, or smaller, or any sub-range or combination thereof.

The dispersible activated bauxite granules 1 may further include mineral particles. The mineral particles may be coherently agglomerated in the dispersible activated bauxite granules 1, agglomerated with the dispersible activated bauxite granules 1, or intermixed with the dispersible activated bauxite granules 1.

In one embodiment, the dispersible activated bauxite granules 1 include by weight, 5-80% activated bauxite domain 2, 10-95% supplemental domain 3, and, optionally, 1-50% water-soluble binder, alternatively 5-50% activated bauxite domain 2, 10-95% supplemental domain 3, and, optionally, 1-50% water-soluble binder, alternatively 30-40% activated bauxite domain 2, 30-40% supplemental domain 3, and 20-40% water-soluble binder, alternatively 35% activated bauxite domain 2, 35% supplemental domain 3, and 30% water-soluble binder. In a further embodiment, the dispersible activated bauxite granules 1 include by weight, 5-50% activated bauxite domain 2, 10-70% supplemental domain 3, up to 50% water-soluble binder, and up to 20% surfactants and emulsifiers combined, alternatively consist of, by weight, 5-50% activated bauxite domain 2, 10-50% supplemental domain 3, up to 50% water-soluble binder, and up to 5% surfactants and emulsifiers combined.

The dispersible activated bauxite granules 1 may have any suitable size (as measured by diameter based upon the median within the sample). Suitable sizing for the dispersible activated bauxite granules 1 may include, but is not limited to, about 0.4 mm to about 4.0 mm, alternatively about 0.4 mm to about 1.2 mm, alternatively about 0.9 mm to about 1.5 mm, alternatively about 1.2 mm to about 1.8 mm, alternatively about 1.5 mm to about 2.1 mm, alternatively about 1.8 mm to about 2.4 mm, alternatively about 2.1 mm to about 2.7 mm, alternatively about 2.4 mm to about 3.0 mm, alternatively about 2.7 mm to about 3.3 mm, alternatively about 3.0 mm to about 3.6 mm, alternatively about 3.3 mm to about 4.0 mm, alternatively about 0.4 mm, alternatively about 0.5 mm, alternatively about 0.6 mm, alternatively about 0.7 mm, alternatively about 0.8 mm, alternatively about 0.9 mm, alternatively about 1.0 mm, alternatively about 1.1 mm, alternatively about 1.2 mm, alternatively about 1.3 mm, alternatively about 1.4 mm, alternatively about 1.5 mm, alternatively about 1.6 mm, alternatively about 1.7 mm, alternatively about 1.8 mm, alternatively about 1.9 mm, alternatively about 2.0 mm, alternatively about 2.1 mm, alternatively about 2.2 mm, alternatively about 2.3 mm, alternatively about 2.4 mm, alternatively about 2.5 mm, alternatively about 2.6 mm, alternatively about 2.7 mm, alternatively about 2.8 mm, alternatively about 2.9 mm, alternatively about 3.0 mm, alternatively about 3.1 mm, alternatively about 3.2 mm, alternatively about 3.3 mm, alternatively about 3.4 mm, alternatively about 3.5 mm, alternatively about 3.6 mm, alternatively about 3.7 mm, alternatively about 3.8 mm, alternatively about 3.9 mm, alternatively about 4.0 mm, alternatively more than about 4.0 mm, or any sub-range or combination thereof. In one non-limiting example, golf greens may use dispersible activated bauxite granules 1 of about 0.5 mm to about 0.8 mm. In another non-limiting example, corn may use dispersible activated bauxite granules 1 via a broadcast application of about 2.4 mm. In a third non-limiting example, any crop with a strip-till machine application may use dispersible activated bauxite granules 1 of about 1.5 mm. In one embodiment, suitable, for example, for application as a suspension, the dispersible activated bauxite granules 1 are micronized, and have a particle size less than about 200 μm, alternatively less than about 150 μm, alternatively less than about 100 μm, alternatively less than about 75 μm, alternatively less than about 1 μm, alternatively less than about 1 μm, alternatively less than about 50 μm, alternatively less than about 25 μm, alternatively less than about 10 μm, alternatively less than about 5 μm, alternatively less than about 2 μm, alternatively less than about 1 μm, alternatively less than about 0.75 μm, alternatively less than about 0.5 μm, alternatively less than about 0.25 μm, alternatively less than about 0.1 μm, alternatively less than about 0.05 μm, alternatively less than about 0.01 μm, as measured by largest particle dimension.

The at least one activated bauxite domain 2 may have an alumina content of at least 35 wt % based on the total weight of the at least one activated bauxite domain 2, alternatively at least 40 wt %, alternatively at least 45 wt %, alternatively at least 50 wt %, alternatively at least 55 wt %. The at least one activated bauxite domain 2 may have a combined alumina and iron oxide content of at least 55 wt % based on the total weight of the at least one activated bauxite domain 2, alternatively at least 60 wt %, alternatively at least 65 wt %, alternatively at least 70 wt %, alternatively at least 75 wt %. The at least one activated bauxite domain 2 may include activated mineral bauxite free of chemical modification with NaOH. The at least one activated bauxite domain 2 may include at least one of activated lateritic bauxite or activated karst bauxite.

In one embodiment, dispersible activated bauxite granules 1 include activated bauxite particles and water-soluble binder agglomerating the plurality of activated bauxite particles into the dispersible activated bauxite granules 1. The activated bauxite particles are free of chemical modification with NaOH.

The activated bauxite particles may have an alumina content of at least 35 wt % based on the total weight of the activated bauxite particles, alternatively at least 40 wt %, alternatively at least 45 wt %, alternatively at least 50 wt %, alternatively at least 55 wt %. The activated bauxite particles may have a combined alumina and iron oxide content of at least 55 wt % based on the total weight of the activated bauxite particles, alternatively at least 60 wt %, alternatively at least 65 wt %, alternatively at least 70 wt %, alternatively at least 75 wt %. The activated bauxite particles may include at least one of activated lateritic bauxite or activated karst bauxite. The dispersible bauxite granules 1 may further include at least one of a suspension agent or an emulsifying agent. The dispersible bauxite granules 1 may have a moisture content, by weight, of less than 10%, alternatively less than 8%, alternatively less than 6%, alternatively less than 5%, alternatively less than 4%, alternatively less than 3%, alternatively less than 2%, alternatively less than 1%. The dispersible bauxite granule 1 may have any suitable size, including, but not limited to, a size of less than 0.6 mm, alternatively less than 0.5 mm, alternatively less than 0.4 mm, alternatively less than 0.3 mm, alternatively less than 0.2 mm, alternatively less than 0.1 mm.

### EXAMPLES

### Experimental Methods

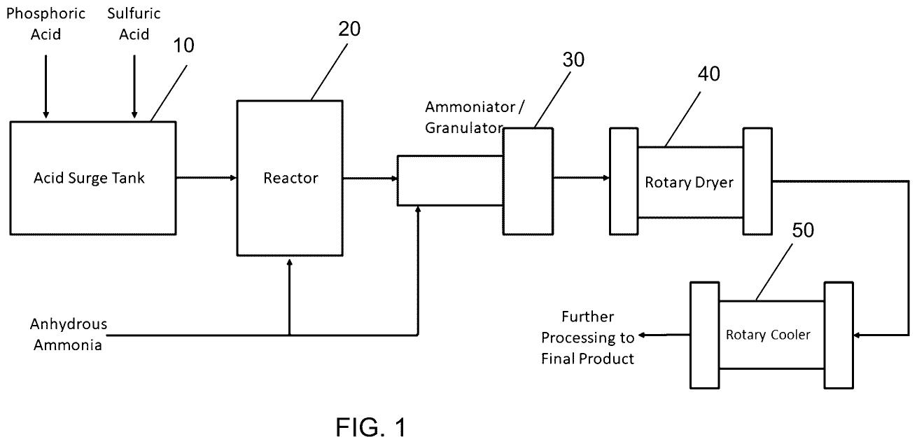

Three granulation studies were performed to obtain the data disclosed herein. All were performed at the International Fertilizer Development Center (“IFDC”) in a large-scale pilot plant (“LSPP”). A generic configuration of the plant is represented in FIG. 1, as a pre-neutralization step utilized for chemical granulation. Steam granulation was also accomplished on the same system, though use of the pre-neutralizer was not necessary.

Phosphoric acid was stored in two 4,150 L stainless steel cone-bottomed tanks (Hall tanks). The phosphoric acid in the storage tanks was recirculated using a centrifugal pump for homogenization prior to transfer to a 1,300 L stainless steel feed tank. The phosphoric acid in the feed tank was recirculated to prevent settling of solids. A centrifugal pump was used to transfer the phosphoric acid from the feed tank to the reactor.

During the first two tests, phosphoric acid and ammonia were chemically reacted to produce an ammonium phosphate slurry with an NH₃:H₃PO₄ mole ratio of approximately 0.55:1. The flow rate of the phosphoric acid to the pre-neutralizer was controlled using a magnetic flow meter. The flow rate was measured every 30 minutes using a stopwatch, a beaker, and a scale. The phosphoric acid was fed through a 1.27 cm diameter pipe discharging into the pre-neutralizer through a funnel located on the pre-neutralizer cover. Ammonia was fed through a drilled pipe sparger located at the bottom of the pre-neutralizer. The ammonia sparger had 10 holes, each having a 4.76 mm diameter, drilled in the pipe facing downward toward the bottom of the vessel. The ammonia flow was measured using an armored rotameter. When needed, tap water was fed through a 1.27 cm diameter tubing monitored through the rotameter; however, the flow rate was manually checked every 30 minutes.

The pre-neutralizer was 61 cm in diameter and 201 cm high with a 9 cm shallow cone bottom. The pre-neutralizer was equipped with a variable speed agitator fitted with three axial-flow thrust turbines. From the pre-neutralizer, the ammonium phosphate slurry was transferred to the drum granulator using a progressive-cavity variable speed pump. The pump speed was varied to maintain, as closely as possible, the calculated slurry flow rate. The slurry was sprayed using a Spraying Systems Whirljet #15 hollow-cone nozzle and discharged 51 cm from the feed end of the granulator.

An exhaust fan was used to pull the pre-neutralizer vent gases through a spray-type scrubber to clean the gases before exhausting them to the atmosphere. Water was used as the scrubbing medium. The exhaust fan and the scrubber system were coated with fluorine-resistant reinforced polyester. The scrubber liquor was discharged to a holding pond.

In both granulation studies, the various bauxite materials were fed to the granulator using an ACCURATE® solids feeder that discharged the bauxite materials into the boot of the granulator elevator, where it mixed with the recycle material before entering the granulator. The flow rate was manually checked every 30 minutes. Three different bauxite materials were used, sourced from three different geographic regions, and identified as “Bauxite #1,” “Bauxite #2,” and “Bauxite #3.”

The granulator was a rotary drum-type granulator, 92 cm in diameter and 180 cm long. A 15 cm retaining dam was located 25.4 cm from the discharge end of the granulator. The granulator was operated at a 1.5-degree angle of inclination from horizontal. Gascous ammonia was fed to the granulator through a drilled stainless steel distributor (sparger) submerged under the rolling bed of the material. The targeted NH₃:H₃PO₄ mole ratio was about 1:1. Steam and/or water were optionally added to the granulator through the drilled sparger to control granule population.

Gases drawn from the granulator were treated in a once-through venturi-type scrubber before being exhausted into the atmosphere. The scrubbing system used water as the scrubbing media and was a reinforced polyester venturi-type scrubber with a reinforced polyester recirculation seal tank having a capacity of approximately 227 liters, a recirculating pump, and a 316L stainless steel fan. The scrubber liquor was not returned to the process; it was sent to an effluent pond after each test.

Moist granular material from the granulator was discharged by gravity into a rotary drum-type dryer, measuring 92 cm in diameter by 730 cm in length. The rotating and cascading bed of material in the dryer was dried using co-current airflow. A natural gas-fired direct-flame combustion chamber was located at the inlet (material feed end) of the dryer. The operating temperature of the dryer was controlled indirectly by measuring the temperature of the dryer discharge material and adjusting for the air-to-gas ratio of the combustion chamber to maintain the desired operating temperature, though the temperature settings were able to be modified manually. The dryer was operated at a 2.0-degree angle of inclination from horizontal and equipped with a band for vibration-inducing hammers.

The dryer exhaust air/gases duct was equipped with a cyclone-type dust collector located between the dryer discharge and the dryer fan. Dust collected in the dryer cyclone was not returned to the process and was weighed before being disposed. Gases drawn from the dryer were treated in a wet scrubber before being exhausted into the atmosphere. The scrubbing system used water as the scrubbing media and included a 316 L stainless steel recirculation tank with a capacity of approximately 4,200 L, a stainless steel recirculating pump, and a 316 L stainless steel fan. Airflow through the dryer ranged from 3,000 to 4,000 cubic meters per hour. The resulting scrubber liquor was not returned to the process but was sent to an effluent pond.

A centrifugal bucket elevator was used to transfer the material from the dryer to an inclined double-deck mechanically vibrated screening system. The screen housing was fitted with a Ty-Rod 4.75 mm oversize screen and a Ty-Rod 2.36 mm undersize screen to yield a product in the 2.36 mm to 4.75 mm size range. Oversize material from the screening system was routed to a chain mill.

The crushed material discharging from the chain mill was returned to the screening system. Undersize material from the screening system was returned (recycled) to the granulator along with a controlled fraction of the product-size material to maintain granulation control, when appropriate. The product-size material from the screening system was transferred to a product cooler that was operated with co-current airflow vented to the fugitive dust collection system. Product-size material was collected in 1 metric-ton bags.

Dust from the elevators, screening system, product cooler, and conveyors was collected by the fugitive dust collection system. The fugitive dust collection system included a network of pickup ducts that combined prior to entering a cyclone-type dust collector before being exhausted into the atmosphere by a 316 L stainless steel fan. Airflow through the fugitive dust system ranged from 1,000 to 1,200 cubic meters per hour. Dust collected in the cyclone was not returned to the process, but was weighed before being disposed.

Process data from each test was collected every 30 minutes. When possible, depending on the operating conditions, a mid-day product sample, a composite end-of-day product sample, and selected half-hour samples were collected and evaluated in IFDC's chemical laboratories to determine their chemical composition.

Examples were prepared via a standard granulated monoammonium phosphate production method in which phosphoric acid was disposed in an acid surge tank 10 and then reacted with ammonia in a reactor vessel 20 to form monoammonium phosphate. The process was performed in trials using a pre-neutralizer setup. To achieve steam granulation, steam was injected into the rolling bed of the granulator. All material feeds were monitored and used to calculate feed material ratios. Aluminum oxide was mixed with the recycle feeds and fed into the granulator 30 at desired ratios, except for in two trials where the aluminum oxide was directly fed into the pre-neutralizer vessel and was granulated as part of the slurry feed into the granulator 30.

Viscosity was determined using Brookfield Ametek Dial Reading Viscometer, Model LVT.

All product samples collected at the end of each testing period were analyzed for total nitrogen, total P₂O₅, water-soluble P₂O₅, citrate-soluble P₂O₅, aluminum oxide (Al₂O₃), and moisture content. All chemical analyses were performed according to the AOAC International methods, except for total nitrogen which was determined using a combustion analyzer. Moisture content was determined using the vacuum desiccator method.

Coherent dispersible granules 1 were characterized by size analysis, crush strength, abrasion resistance, and impact resistance, as summarized in Table 1. Granule size analysis was performed using the sieve method outlined in Procedure IFDC S-107-1 in the Manual for Determining Physical Properties of Fertilizer (IFDC R-10). This method determined Size Guide Number (SGN) and Uniformity Index (U.I.). Granule crush strength was determined using a force sensor following the Procedure IFDC S-115 in the Manual for Determining Physical Properties of Fertilizer (IFDC R-10). Abrasion resistance was determined by rolling granules alongside steel balls as outlined in the Procedure IFDC S-116 in the Manual for Determining Physical Properties of Fertilizer (IFDC R-10). Impact resistance was determined by impacting the granules within a bagged system as outlined in the Procedure IFDC S-118 in the Manual for Determining Physical Properties of Fertilizer (IFDC R-10).

### Study 1

Monoammonium phosphate (MAP) was produced on the system via chemical granulation to standardize production parameters. Bauxite #1 was introduced into the system at varying input inclusion rates (10.31%, 20.63%, 30%, 40%, and 50%).

### Study 2

Granulated MAP was milled to a powder with size distribution ranging from −100 mesh to 4 mm. The powdered MAP was re-granulated via steam granulation in the IFDC LSPP system to standardize production parameters. Bauxite #1 was then introduced into the system at varying input inclusion rates (10.31%, 20.63%, 30%, 40%, and 50%).

### Study 3

Monoammonium phosphate (MAP) was produced on the system via chemical granulation to standardize production parameters. Bauxite #1 was introduced into the system at varying input inclusion rates (20.63%, 30%, and 40%). The remaining material within the system was bled out, and Bauxite #2 was introduced at the same input inclusion rates. Again, the material within the system was bled out, and Bauxite #3 was introduced at the same input inclusion rates.

### Phosphate Release Study

The granulated materials from Study 1 were evaluated for their phosphate release characteristics in water. The phosphate release curves were obtained by placing a designated weight of granules (0.3 g of phosphate) into 50 mL of deionized water and monitoring phosphate concentrations in the water reservoir at designated time points. Aliquots of liquid were removed and replaced from the liquid reservoir at periodic time points. Filtrate phosphate concentrations were analyzed colorimetricaly by the Murphy and Riley (1962) procedure using a SEAL AQ 400 autoanalyzer, Method EPA-118-A Rev.5 (SEAL Analytical, 2004).

Referring to FIG. 6, the predicted available P₂O₅ is compared to the measured available P₂O₅ of the produced granules. The predicted available P₂O₅ was based on an input bauxite raw material inclusion being equal to the output bauxite inclusion in the finished granule. Since the slope of m=1.455 is statistically greater than a slope of m=1, it was demonstrated that a mass loss was observed from the input bauxite. Since bauxite “activation” is defined as a loss of bound water from the bauxite crystalline structure, this change evidences that crystalline water was removed from the bauxite during the granulation process.

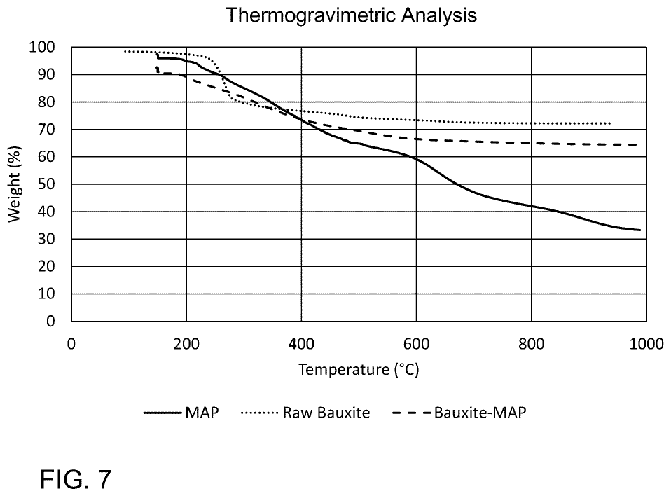

Referring to FIG. 7, thermogravimetric analysis (“TGA”) curves over a temperature range of 25° C. to 1,000° C. of the produced bauxite-embedded ammonium phosphate granules, produced monoammonium phosphate, and raw bauxite are shown (Bauxite #1). The raw bauxite curve clearly demonstrates that trihydrate water is removed over a temperature range of 250° C. to 375° C. and monohydrate water is removed over a range of 375° C. to 550° C. The granule TGA curve does not show the proper proportion of trihydrate or monohydrate water loss at the appropriate temperature range, indicating that the bound water had already been lost prior to testing, evidencing that the bound water was removed during the granulation process.

As shown in Table 1, the type of Granulation had an impact on the degree of bauxite activation. Chemical granulation shows greater crystalline water loss from bauxite than steam granulation. As shown in Table 2, the combustion chamber temperature of the dryer also had an impact on activation, indicating that some of the crystalline water loss occurs in the rotary dryer.

TABLE 1
Effect of Granulation on Bauxite Activation

| | Average Dryer | Average | Calculated Loss- |
|---|---|---|---|
| Type of | Combustion Chamber | Crystalline | on-Ignition |
| Granulation | Temperature (° C.) | Water Loss (%) | (L.O.I) (%) |
| Chemical | 412 | 17.8% | 8.8% |
| Steam | 488 | 12.0% | 14.6% |

TABLE 2
Effect of Drying Temperature on Bauxite Activation

| | Average Dryer | Average | Calculated Loss- |
|---|---|---|---|
| Chemical | Combustion Chamber | Crystalline | on-Ignition |
| Granulation | Temperature (° C.) | Water Loss (%) | (L.O.I.) (%) |
| Low Dryer | 308 | 14.5% | 12.1% |
| Temp | | | |
| High Dryer | 482 | 20.0% | 6.6% |
| Temp | | | |

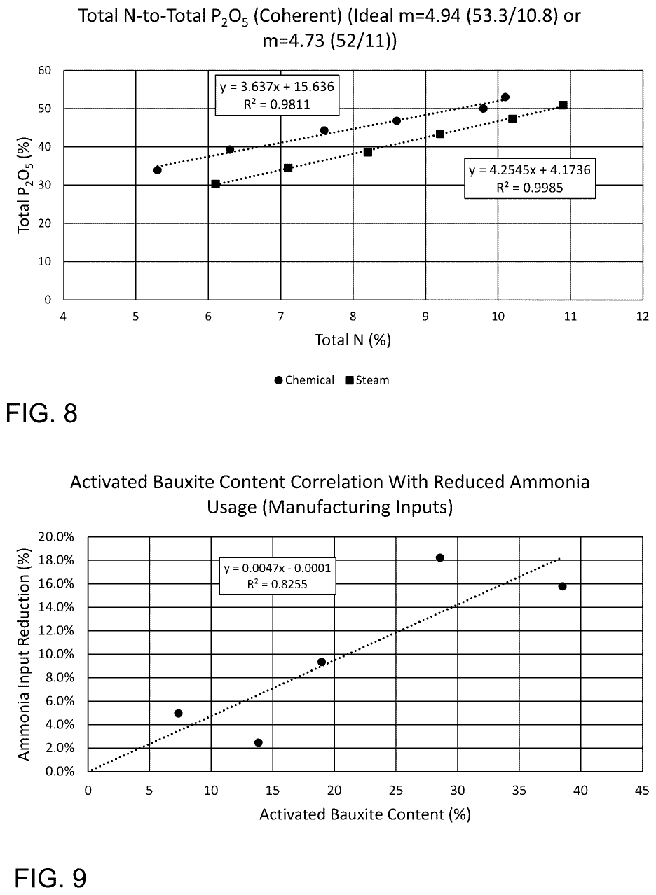

Referring to FIG. 8, the measured total nitrogen content of the granules was compared to the total P₂O₅ content. Since monoammonium phosphate is designed to be produced at a 1:1 mole ratio, the slope should remain consistent based on the mole ratio regardless of additional inputs (in this case, the slope was expected to be m=4.94, based on the total P₂O₅ mass input divided by the total nitrogen mass input (53.3/10.8)). However, the slopes for both chemical and steam granulation are statistically lower than m=4.94 when bauxite is introduced at varying concentrations, indicating that ammonia requirements were lessened compared to phosphoric acid during manufacturing. This indicates that the phosphoric acid interacts chemically with the bauxite and outcompetes ammonia molecules for reaction sites. The introduction of bauxite lowers ammonia requirements to achieve granulation.

Referring to FIG. 9, inclusion of bauxite reduced ammonia requirements to achieve granulation. During manufacturing, material inputs are adjusted periodically by the plant operators to maintain adequate granulatability. As greater amounts of bauxite are included as material inputs, the ammonia requirements were reduced below projected input rates in tandem with bauxite input.

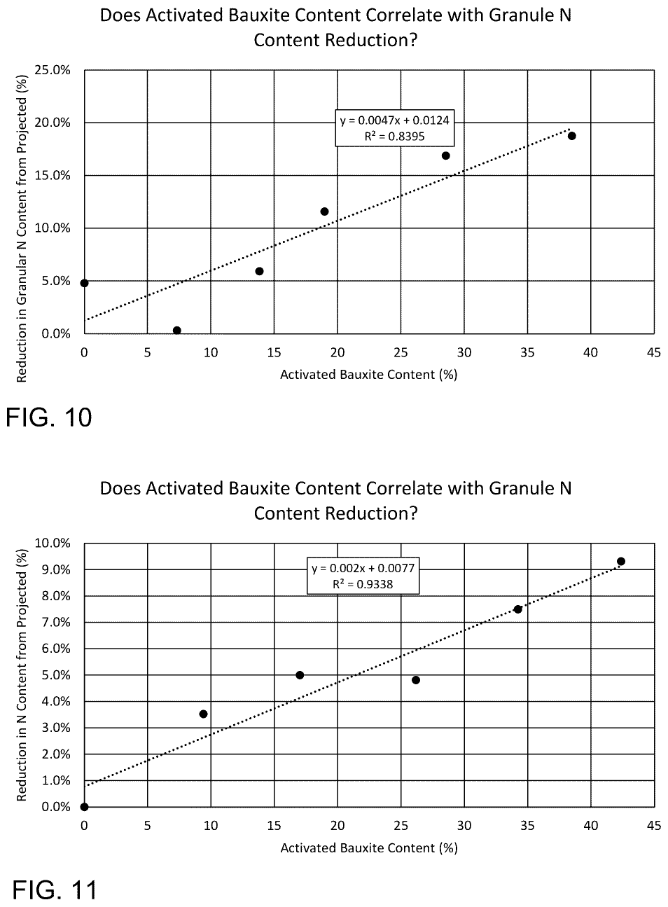

Referring to FIG. 10, the reduction in granular nitrogen content from the projected amount is plotted as a function of activated bauxite content present in the granule for granules produced via chemical granulation. The reduction in ammonia inputs carries over to the final granular nitrogen content, further evidencing that bauxite reduces nitrogen requirements in manufacturing.

Referring to FIG. 11, the reduction in granular nitrogen content from the projected amount is plotted as a function of activated bauxite content present in the granule for granules produced via steam granulation. While a nitrogen reduction was observed, the rate of reduction was lower than that for granules produced via chemical granulation, indicating that the level of bauxite activation had effect on the effectiveness of the bauxite to interact with the phosphoric acid.

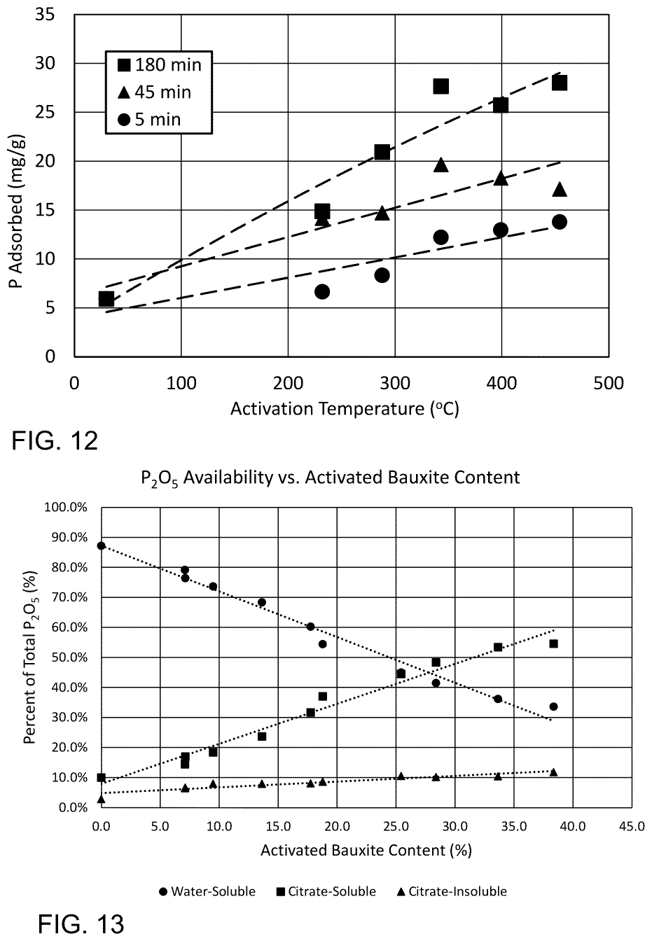

Referring to FIG. 12, it is shown that greater activation of bauxite resulted in greater phosphate adsorption.

Referring to FIG. 13, P₂O₅ availability was compared to activated bauxite content for granules produced via chemical granulation. Granular P₂O₅ transitioned from water-soluble to citrate-soluble when greater amounts of bauxite were included in the granule. This transition demonstrates that phosphate molecules are interacting with the solid bauxite particles in a controlled fashion.

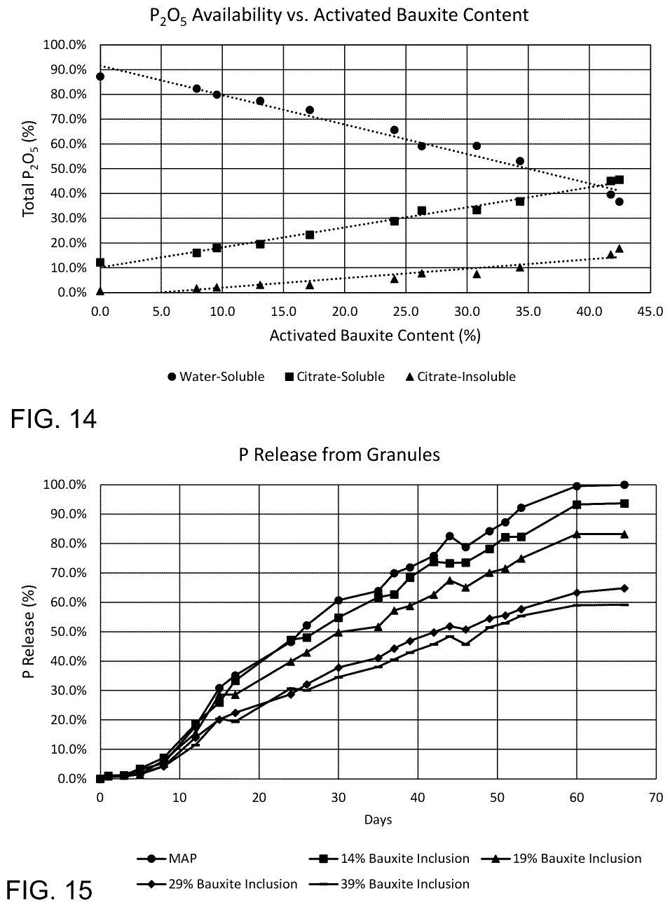

Referring to FIG. 14, P₂O₅ availability was compared with activated bauxite content for granules produced via steam granulation. Granular P₂O₅ transitioned from water-soluble to citrate-soluble when greater amounts of bauxite were included in the granule. This transition demonstrates that phosphate molecules are interacting with the solid bauxite particles in a controlled fashion. However, this transition occurs more slowly when granules are produced via steam granulation rather than chemical granulation, further demonstrating that the quantity of crystalline water removed from the bauxite lattice plays a significant role in the quantity of phosphate that will be interacted with.

Referring to FIG. 15, a comparison of the percent of phosphate release from granules produced via chemical granulation with different bauxite inclusion rates over a 66-day period showed that as bauxite inclusion increased within the granules, the rate of phosphate release was slowed.

TABLE 3
Select Characteristics of Tested Bauxites

| | | | | | | | Surface | | | Specific |
|---|---|---|---|---|---|---|---|---|---|---|
| Sample | Composition (wt %) | | | | | LOI | Area (m²/g) | | pH | Gravity |
| ID | Al₂O₃ | Fe₂O₃ | TiO₂ | CaO | SiO₂ | (wt %) | Raw | Calcined | (PZC) | (g/cm³) |
| 1 | 47.59 | 20.33 | 2.38 | 0.37 | 0.92 | 26.62 | 30.91 | 235.95 | 8.05 | 2.766 |
| 2 | 59.44 | 2.59 | 2.57 | 0.00 | 6.81 | 28.26 | 8.03 | 256.92 | 7.13 | 2.572 |
| 3 | 63.53 | 0.34 | 1.38 | 0.02 | 1.15 | 32.86 | 2.58 | 134.38 | 4.36 | 2.473 |

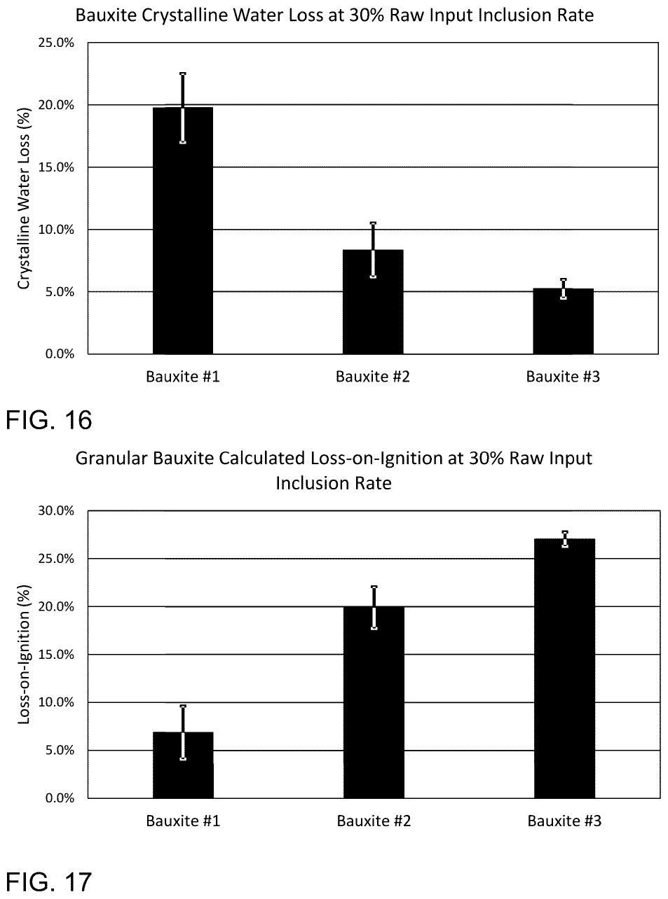

Referring to FIG. 16, the crystalline water loss during chemical granulation of each of the evaluated bauxites was calculated. To standardize manufacturing, dryer temperatures were all targeted at 450° C., and bauxites were input at 30% on a dry manufacturing basis.

Referring to FIG. 17, the loss-on-ignition of each of the bauxites present in the granules following chemical granulation was calculated. The differences suggest that different bauxites will be “activated” to different levels while undergoing the same process due primarily to bauxite physicochemical characteristics.

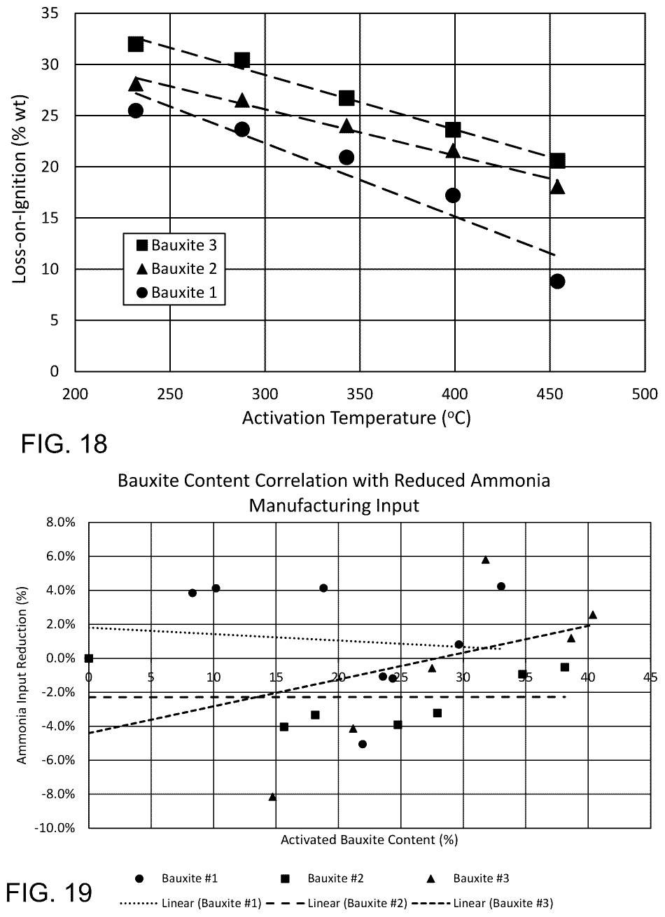

Referring to FIG. 18, the differences in the propensity to volatilize crystalline water from lattices for the various evaluated bauxites were measured. Bauxite #1 exhibits a lower loss-on-ignition (“LOI”) at temperatures lower than those for Bauxite #2 and Bauxite #3, indicating an increased propensity for activation. These differences suggest that iron oxide content may play a role in the propensity of bauxite to activate.

Referring to FIG. 19, activated bauxite content and the reduction in ammonia input into the chemical granulation process from the expected were correlated. Granulation was achievable without substantially reducing ammonia input in this experiment.

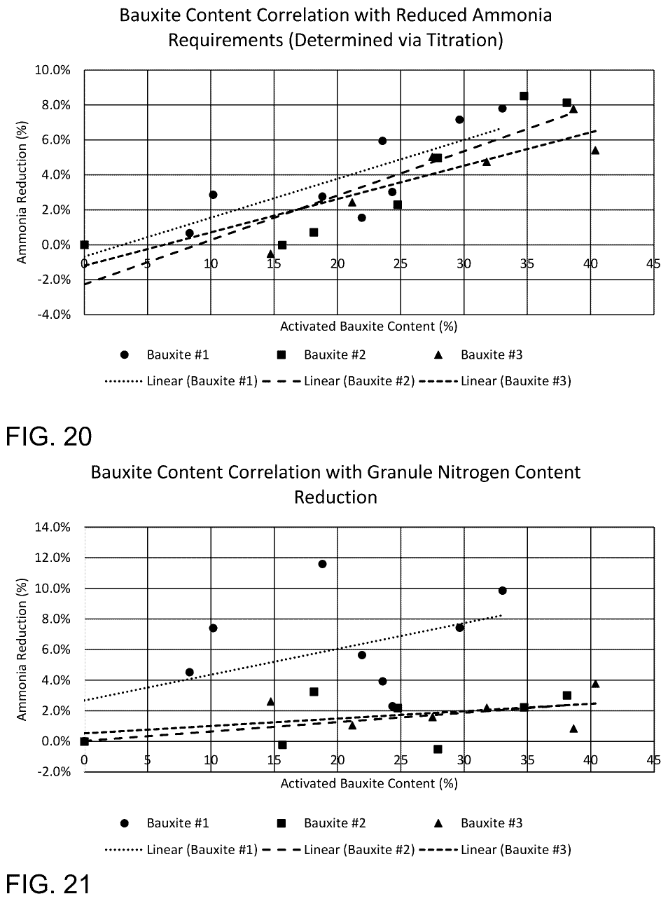

Referring to FIG. 20, the calculated ammonia reduction based on the ammonia-phosphoric acid imbalance as determined via titration of granules exiting the granulator was compared to the activated bauxite content of the granules. Despite no reduction in ammonia input (FIG. 18), a clear trend of increasing ammonia reduction is apparent as activated bauxite content increased for all three tested bauxites. This trend indicates that greater amounts of free unreacted ammonia must be present in the granules as greater amounts of bauxite are included, suggesting that the bauxites are outcompeting the ammonia molecules for phosphoric acid sites. Ultimately, this result indicates that ammonia levels should non-intuitively be reduced when co-granulating with bauxites.

Referring to FIG. 21, the calculated ammonia reduction based on the ammonia-phosphoric acid imbalance was determined by total P₂O₅ and total nitrogen analyses in comparison to the activated bauxite content in the finished granules. Despite no reduction in ammonia input (FIG. 18), a clear trend of increasing ammonia reduction was apparent as activated bauxite content increased for all three tested bauxites. Since the trend of maintaining free unreacted ammonia within the granules remained immediately following granulation (FIG. 19), this suggests that a considerable proportion of the unreacted ammonia was volatilized throughout the manufacturing process. Due to the environmental consequences of this ammonia volatilization, reduction of ammonia inputs proportionally to bauxite inputs would be desirable, contrary to what would be expected.

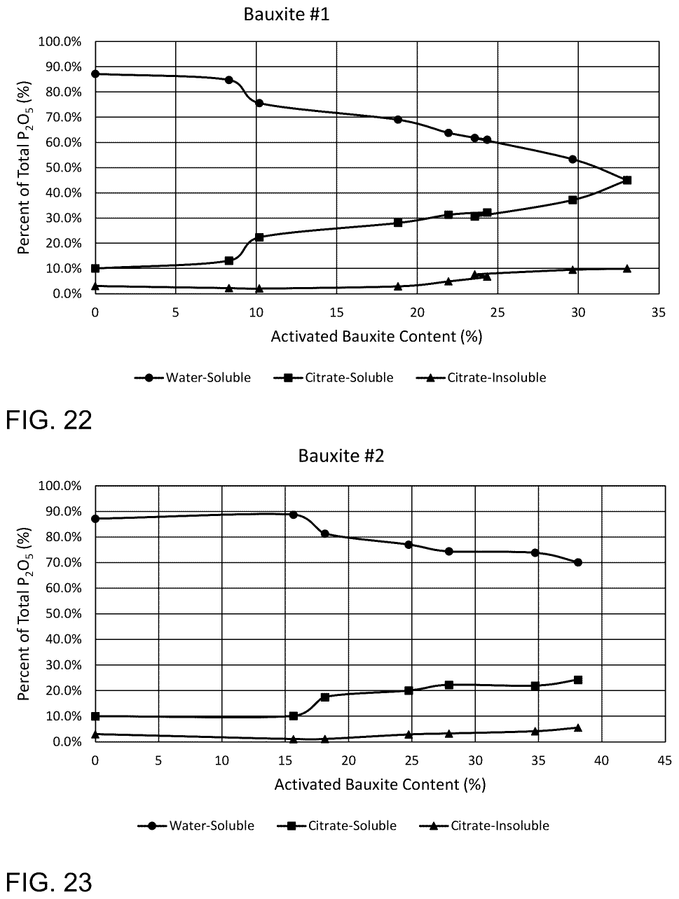

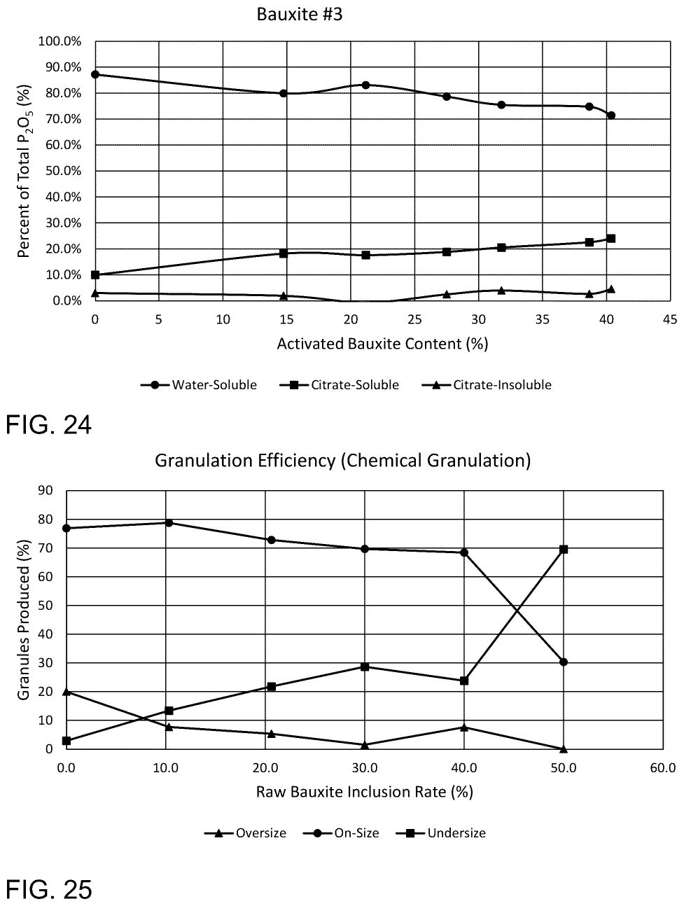

Referring to FIGS. 22-24, the percentage of water-soluble P₂O₅, citrate-soluble P₂O₅, and citrate-insoluble P₂O₅ present out of total P₂O₅ din the granules produced via chemical granulation of (FIG. 22) Bauxite #1, (FIG. 23) Bauxite #2, and (FIG. 24) Bauxite #3 were measured. Bauxite #1 showed the greatest propensity to transition from water-soluble to citrate-soluble P₂O₅ as bauxite content increased, indicating that the level of bauxite activation played a role in the controlled-release properties of phosphate.

Table 4 presents a comparison of the characteristics of each of the produced granules. There were no deleterious effects on granule quality from the inclusion of any of the three evaluated bauxites.

TABLE 4
Characteristics of the Produced Granules

| | Activated | Crush | | | | |
|---|---|---|---|---|---|---|
| | Bauxite | Strength | | | | Impact |
| | Content | (lbf) | Size | | Abrasion | Resistance |
| | (Based off | (2.38- | Guide | | Resistance | (% |
| | Al₂O₃ | 2.80 mm | Number | Uniformity | (% | Shattered |
| Trial | measurement) | granules) | (SGN) | Index | Degradation) | Granules) |
| MAP | 0.0% | 5.8 | 409 | 61 | 0.89% | 2.76% |
| Bauxite | 23.6% | 5.7 | 364 | 63 | 0.98% | 2.02% |
| #1-MAP | | | | | | |
| (30% | | | | | | |
| Inclusion) | | | | | | |
| Bauxite | 27.9% | 4.3 | 392 | 58 | 0.98% | 2.96% |
| #2-MAP | | | | | | |
| (30% | | | | | | |
| inclusion) | | | | | | |
| Bauxite | 27.5% | 6.0 | 375 | 62 | 0.37% | 1.34% |
| #3-MAP | | | | | | |
| (30% | | | | | | |
| inclusion) | | | | | | |

Referring to FIG. 25, the granulation efficiency of Bauxite #1-MAP, Bauxite #1-MAP, and Bauxite #1-MAP were measured by the proportion of oversize, on-size, and undersize granules that were produced upon exiting the rotary dryer. These results suggest that achieving granulatability above 50% bauxite inclusion may present scalability issues under the examined conditions.

While the foregoing specification illustrates and describes exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. Dispersible activated bauxite granules, comprising:
at least one activated bauxite domain; and
at least one supplemental domain selected from the group consisting of at least one nutrient domain, at least one pesticide domain, at least one biological additive domain, at least one sorbent domain, and combinations thereof,
wherein the at least one activated bauxite domain and the at least one supplemental domain are present in the dispersible activated bauxite granule as distinct domains clustered together.

2. The dispersible activated bauxite granules of claim 1, wherein the dispersible activated bauxite granules are coherent dispersible activated bauxite granules and the at least one activated bauxite domain and the at least one supplemental domain are present in the coherent dispersible activated bauxite granules as distinct domains coherently agglomerated together such that the coherent dispersible activated bauxite granules have a coherent dispersible bauxite granule crush strength of at least 5 lbf.

3. The dispersible activated bauxite granules of claim 1, wherein the dispersible activated bauxite granules are agglomerated dispersible activated bauxite granules.

4. The dispersible bauxite granules of claim 1, wherein the at least one supplemental domain includes the at least one nutrient domain, and the at least one nutrient domain includes at least one additive selected from the group consisting of bioavailable species of phosphorus, molybdenum, selenium, zinc, copper, cobalt, iron, nickel, manganese, vanadium, calcium, potassium, sulfur, chlorine, silicon, magnesium, sodium, nitrogen, boron, and combinations thereof.

5. The dispersible activated bauxite granules of claim 4, wherein the at least one nutrient domain includes at least one phosphate domain as the bioavailable species of phosphorus, the at least one phosphate domain is selected from the group consisting of diammonium phosphate, monoammonium phosphate, triple superphosphate, single superphosphate, nitrophosphate, and combinations thereof.

6. (canceled)

7. (canceled)

8. (canceled)

9. (canceled)

10. (canceled)

11. The dispersible activated bauxite granules of claim 1, wherein the at least one activated bauxite domain and the at least one supplemental domain are intragranularly homogenously distributed in the dispersible activated bauxite granules.

12. (canceled)

13. The dispersible activated bauxite granules of claim 1, having an activated bauxite domain: supplemental domain weight ratio from 5:1 to 1:5.

14. The dispersible activated bauxite granules of claim 1, further including at least one of a water-soluble binder, a suspension agent, or an emulsifying agent.

15. The dispersible activated bauxite granules of claim 1, further including at least one additional domain present as a distinct domain, wherein the at least one additional domain is selected from the group consisting of the at least one nutrient domain, the at least one pesticide domain, the at least one biological additive domain, the at least one sorbent domain, and combinations thereof.

16. The dispersible activated bauxite granules of claim 15, wherein the at least one additional domain is coherently agglomerated with the at least one activated bauxite domain and the at least one supplemental domain in the dispersible activated bauxite granules.

17. The dispersible activated bauxite granules of claim 15, wherein the at least one additional domain is agglomerated with the at least one activated bauxite domain and at least one supplemental domain in the dispersible activated bauxite granules.

18. The dispersible activated bauxite granules of claim 15, wherein the at least one additional domain is coated onto the clustered together at least one bauxite domain and the at least one supplemental domain.

19. The dispersible activated bauxite granules of claim 1, wherein the at least one activated bauxite domain has an alumina content of at least 35 wt % based on the total weight of the at least one activated bauxite domain.

20. The dispersible activated bauxite granules of claim 1, wherein the at least one activated bauxite domain has a combined alumina and iron oxide content of at least 55 wt % based on the total weight of the at least one activated bauxite domain.

21. The dispersible activated bauxite granules of claim 1, wherein the at least one activated bauxite domain includes activated mineral bauxite free of chemical modification with NaOH.

22. (canceled)

23. Dispersible activated bauxite granules, comprising:
activated bauxite particles; and
water-soluble binder agglomerating the plurality of activated bauxite particles into the dispersible activated bauxite granules,
wherein the activated bauxite particles are free of chemical modification with NaOH.

24. (canceled)

25. The dispersible activated bauxite granules of claim 23, wherein the activated bauxite particles have an alumina content of at least 35 wt % based on the total weight of the activated bauxite particles.

26. The dispersible activated bauxite granules of claim 23, wherein the activated bauxite particles have a combined alumina and iron oxide content of at least 55 wt % based on the total weight of the activated bauxite particles.

27. (canceled)

28. The dispersible activated bauxite granules of claim 23, further including at least one of a suspension agent or an emulsifying agent.

29. The dispersible activated bauxite granules of claim 23, wherein the dispersible activated bauxite granules have a moisture content, by weight, of less than 10%, and a size of less than 0.6 mm.

30. (canceled)

31. (canceled)

32. (canceled)

33. (canceled)

34. (canceled)

35. (canceled)

36. (canceled)

37. (canceled)

38. (canceled)

39. A method for forming coherent dispersible activated bauxite granules, comprising:
mixing ground alkaline rock and at least one of phosphoric acid, sulfuric acid, or nitric acid in a reactor;
reacting the ground alkaline rock with the at least one of the phosphoric acid, the sulfuric acid, or the nitric acid in the reactor to form at least one of a superphosphate slurry or a nitrophosphate slurry;
introducing bauxite particles into the presence of the at least one of the superphosphate slurry or the nitrophosphate slurry;
co-agglomerating the at least one of the superphosphate slurry or the nitrophosphate slurry and the bauxite particles in a rotary drum granulator to form coherent dispersible granules; and
drying the coherent dispersible granules,
wherein at least one of the introducing bauxite particles into the presence of the at least one of the superphosphate slurry or the nitrophosphate slurry or the drying the coherent dispersible granules activates the bauxite particles so as to form the coherent dispersible activated bauxite granules having a coherent dispersible activated bauxite granule crush strength of at least 5 lbf.

40. The method of claim 39, wherein the ground alkaline rock is ground phosphate rock.

41. The method of claim 39, wherein introducing the bauxite particles into the presence of the at least one of the superphosphate slurry or the nitrophosphate slurry includes premixing the bauxite particles with the at least one of the phosphoric acid, the sulfuring acid, or the nitric acid prior to mixing the at least one of the phosphoric acid, the sulfuric acid, or the nitric acid with the ground alkaline rock.

42. The method of claim 39, wherein introducing the bauxite particles into the presence of the at least one of the superphosphate slurry or the nitrophosphate slurry includes adding the bauxite particles into at least one of an acid control tank upstream of the reactor, an alkaline rock weigher feeder upstream of the reactor, the reactor, or the rotary drum granulator.

43. (canceled)

44. (canceled)

45. (canceled)

46. (canceled)

47. (canceled)

48. (canceled)

49. (canceled)

50. (canceled)

51. (canceled)

52. A method for forming agglomerated dispersible activated bauxite granules, comprising:
physically blending bauxite particles with supplemental particles selected from the group consisting of nutrient particles, pesticide particles, biological particles, sorbent particles, and combinations thereof;
agglomerating the bauxite particles with the supplemental particles and at least one water-soluble binder to form agglomerated dispersible granules; and
drying the agglomerated dispersible granules at a temperature of at least 250° F. to form the agglomerated dispersible activated bauxite granules.

53. The method of claim 52, wherein the nutrient particles include constituents selected from the group consisting of bioavailable species of phosphorus, molybdenum, selenium, zinc, copper, cobalt, iron, nickel, manganese, vanadium, calcium, potassium, sulfur, chlorine, silicon, magnesium, sodium, nitrogen, boron, and combinations thereof.

54. The method of claim 53, wherein the nutrient particles include phosphate as the bioavailable species of phosphorus.

55. (canceled)

56. (canceled)

57. (canceled)

58. (canceled)
